(19) United States
(12) Patent Application Publication
(10) Pub. No.: US 2024/0380540 A1
(43) Pub. Date: Nov. 14, 2024

(54) ALLOCATING RESOURCES FOR RADAR REFERENCE SIGNALS

(71) Applicant: QUALCOMM Incorporated, San Diego, CA (US)

(72) Inventors: Weimin DUAN, San Diego, CA (US); Hung Dinh LY, San Diego, CA (US); Alexandros MANOLAKOS, Athens, Attikí (GR)

(21) Appl. No.: 18/690,680

(22) PCT Filed: Oct. 24, 2022
(86) PCT No.: PCT/US2022/078584

§ 371 Date: Mar. 8, 2024

(30) Foreign Application Priority Data
Nov. 25, 2021 (GR) 20210100824

(51) Int. Cl. H04L 5/00; G01S 7/00; G01S 13/00; H04W 56/00

(52) U.S. Cl. CPC H04L 5/0048; G01S 7/006; G01S 13/003; H04L 5/0053; H04W 56/001

(57) ABSTRACT

Methods and apparatus for allocating resources for radio frequency (RF) reference signals with communications signals are presented. In some embodiments, a transmission reception point (TRP) may transmit (a) a wireless synchronization signal or (b) wireless physical channel data, wherein the wireless synchronization signal comprises a periodically transmitted broadcast signal, and wherein the wireless physical channel data comprises a unicast signal directed to a user equipment (UE); and transmit a radar reference signal multiplexed with the wireless synchronization signal or the wireless physical channel data, wherein the radar reference signal is configured to, when correlated with a reflected version of the radar reference signal, serve as a basis for one or more radar measurements.

### BACKGROUND

### 1. Field of Disclosure

The present disclosure relates generally to the field of wireless communications, and more specifically to allocation of positioning reference signals (e.g., radar signals) in frequency spectra that are occupied by signals used for wireless data communication.

### 2. Description of Related Art

Radio access technologies (RATs) continue to become available for widespread public use and progress through research (e.g., Fifth Generation New Radio (5G NR) and beyond). These advancements in cellular data communications systems demand greater bandwidth and greater spectrum efficiency for delivering larger amounts of data at higher speeds.

Given the increasing demands placed on data communications, there is room to improve the efficiency of positioning systems as well. When positioning based on radar (or other radio frequency (RF)) sensing, there is an opportunity for efficient spectrum allocation, for example, joint communication of radar sensing reference signals and data communications signals. Orthogonal Frequency-Division Multiplexing (OFDM) waveform (and/or its variants) is likely to be considered as the basis for such joint data communication and radar-based sensing. Thus, multiplexing signals at the symbol level may increase the spectrum efficiency by using underutilized resources.

### BRIEF SUMMARY

In one aspect of the present disclosure, a method of multiplexing radar signals with communications signals is disclosed. In one embodiment, the method includes transmitting (a) a wireless synchronization signal or (b) wireless physical channel data, wherein the wireless synchronization signal comprises a periodically transmitted broadcast signal, and wherein the wireless physical channel data comprises a unicast signal directed to a user equipment (UE); and transmitting a radar reference signal multiplexed with the wireless synchronization signal or the wireless physical channel data, wherein the radar reference signal is configured to, when correlated with a reflected version of the radar reference signal, serve as a basis for one or more radar measurements.

In another aspect of the present disclosure, a transmission reception point (TRP) is disclosed. In one embodiment, the TRP comprises: one or more wireless communications interfaces; memory; and one or more processors communicatively coupled to the memory and the one or more wireless communication interface, and configured to: transmit (a) a wireless synchronization signal or (b) wireless physical channel data, wherein the wireless synchronization signal comprises a periodically transmitted broadcast signal, and wherein the wireless physical channel data comprises a unicast signal directed to a user equipment (UE); and transmit a radar reference signal multiplexed with the wireless synchronization signal or the wireless physical channel data, wherein the radar reference signal is configured to, when correlated with a reflected version of the radar reference signal, serve as a basis for one or more radar measurements.

In another aspect of the present disclosure, a base station is disclosed. In one embodiment, the base station comprises: one or more wireless communications interfaces; memory; and one or more processors communicatively coupled to the memory and the one or more wireless communication interface, and configured to: transmit (a) a wireless synchronization signal or (b) wireless physical channel data, wherein the wireless synchronization signal comprises a periodically transmitted broadcast signal, and wherein the wireless physical channel data comprises a unicast signal directed to a user equipment (UE); and transmit a radar reference signal multiplexed with the wireless synchronization signal or the wireless physical channel data, wherein the radar reference signal is configured to, when correlated with a reflected version of the radar reference signal, serve as a basis for one or more radar measurements.

In another aspect of the present disclosure, a non-transitory computer-readable apparatus is disclosed. In one embodiment, the non-transitory computer-readable apparatus includes a storage medium, the storage medium comprising a plurality of instructions configured to, when executed by one or more processors, cause a computerized apparatus to: transmit (a) a wireless synchronization signal or (b) wireless physical channel data, wherein the wireless synchronization signal comprises a periodically transmitted broadcast signal, and wherein the wireless physical channel data comprises a unicast signal directed to a user equipment (UE); and transmit a radar reference signal multiplexed with the wireless synchronization signal or the wireless physical channel data, wherein the radar reference signal is configured to, when correlated with a reflected version of the radar reference signal, serve as a basis for one or more radar measurements.

In another aspect of the present disclosure, a computerized apparatus is disclosed. In one embodiment, the computerized apparatus includes means for transmitting (a) a wireless synchronization signal or (b) wireless physical channel data, wherein the wireless synchronization signal comprises a periodically transmitted broadcast signal, and wherein the wireless physical channel data comprises a unicast signal directed to a user equipment (UE); and means for transmitting a radar reference signal multiplexed with the wireless synchronization signal or the wireless physical channel data, wherein the radar reference signal is configured to, when correlated with a reflected version of the radar reference signal, serve as a basis for one or more radar measurements

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

FIG. 1 is a diagram of a positioning system, according to an embodiment.

FIG. 2 is a diagram of a 5th Generation (5G) New Radio (NR) positioning system, illustrating an embodiment of a positioning system (e.g., the positioning system of FIG. 1) implemented within a 5G NR communication system.

FIG. 3 is a block diagram of a radar system performing radar-based directional proximity sensing, according to an embodiment.

FIG. 4 is a diagram showing the basic operation of a bistatic radar system, according to an embodiment.

FIG. 5 illustrates the implementation of a bistatic radar system in a wireless communications system, according to an embodiment.

FIG. 6 is a diagram showing an example of a frame structure for NR and associated terminology.

FIG. 7 is a diagram showing an example of a radio frame sequence with Positioning Reference Signal (PRS) positioning occasions.

FIG. 8 is a diagram showing example combination (comb) structures, illustrating how RF signals may utilize different sets of resource elements, according to some embodiments.

FIG. 9 is a diagram illustrating a time-frequency structure of a synchronization signal block (SSB), according to one embodiment.

FIGS. 10A-10D are diagrams depicting various example OFDM resource grids representing time-frequency resource allocation schemes for a synchronization signal (e.g., SSB) and one or more radar reference signals (RS).

FIGS. 11A-11D are diagrams depicting various example OFDM resource grids representing time-frequency resource allocation schemes for one or more physical channels and one or more radar RS.

FIG. 12 is a flow diagram of a method for multiplexing radar signals with communications signals, according to one embodiment.

FIG. 13 is a flow diagram of a method for multiplexing radar signals with communications signals, according to another embodiment. FIG. 13A is a flow diagram that details a block shown in the method of FIG. 13, according to some embodiments.

FIG. 14 is a flow diagram of a method for multiplexing radar signals with synchronization signals, according to some embodiments.

FIG. 15 is a flow diagram of a method for multiplexing radar signals with a physical channel, according to some embodiments.

FIG. 16 is a block diagram of an embodiment of a base station, which can be utilized in embodiments as described herein.

FIG. 17 is a block diagram of an embodiment of a UE, which can be utilized in embodiments as described herein.

Like reference symbols in the various drawings indicate like elements, in accordance with certain example implementations. In addition, multiple instances of an element may be indicated by following a first number for the element with a letter or a hyphen and a second number. For example, multiple instances of an element 101 may be indicated as 101-1, 101-2, 101-3 etc. or as 101a, 101b, 101c, etc. When referring to such an element using only the first number, any instance of the element is to be understood (e.g., element 101 in the previous example would refer to elements 101-1, 101-2, and 101-3 or to elements 101a, 101b, and 101c).

### DETAILED DESCRIPTION

The following description is directed to certain implementations for the purposes of describing innovative aspects of various embodiments. However, a person having ordinary skill in the art will readily recognize that the teachings herein can be applied in a multitude of different ways. The described implementations may be implemented in any device, system, or network that is capable of transmitting and receiving radio frequency (RF) signals according to any communication standard, such as any of the Institute of Electrical and Electronics Engineers (IEEE) IEEE 802.11 standards (including those identified as Wi-Fi® technologies), the Bluetooth® standard, code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Rate Packet Data (HRPD), High Speed Packet Access (HSPA), High Speed Downlink Packet Access (HSDPA), High Speed Uplink Packet Access (HSUPA), Evolved High Speed Packet Access (HSPA+), Long Term Evolution (LTE), Advanced Mobile Phone System (AMPS), or other known signals that are used to communicate within a wireless, cellular or internet of things (IoT) network, such as a system utilizing 3G, 4G, 5G, 6G, or further implementations thereof, technology.

As used herein, an “RF signal” comprises an electromagnetic wave that transports information through the space between a transmitter (or transmitting device) and a receiver (or receiving device). As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal.

Additionally, references to “reference signals,” “positioning reference signals,” “reference signals for positioning,” and the like may be used to refer to signals used for positioning of a user equipment (UE) or other objects. As described in more detail herein, such signals may comprise any of a variety of signal types but may not necessarily be limited to a Positioning Reference Signal (PRS) as defined in relevant wireless standards.

As noted above, OFDM waveforms continue to be utilized for high-throughput data communications and RATs (e.g., 5G NR networks). Thus, higher efficiency of OFDM resources are needed. If there are no dedicated slots or sub-slots for RF sensing, joint communication of data and RF sensing signals may be multiplexed at the symbol level to increase the spectrum efficiency of communications networks utilizing radar systems. Additional details will follow after an initial description of relevant systems and technologies.

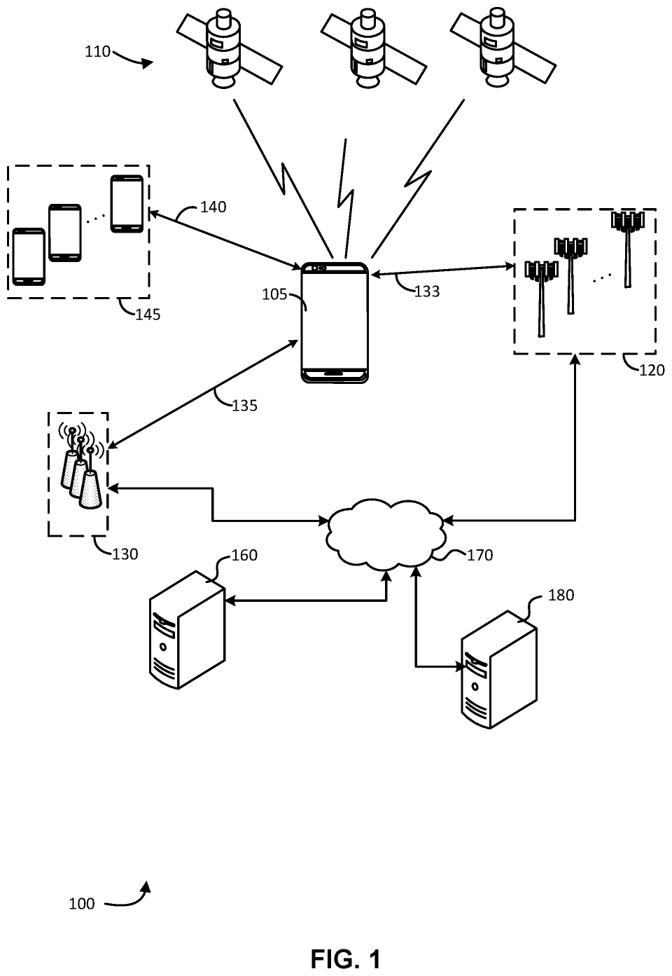

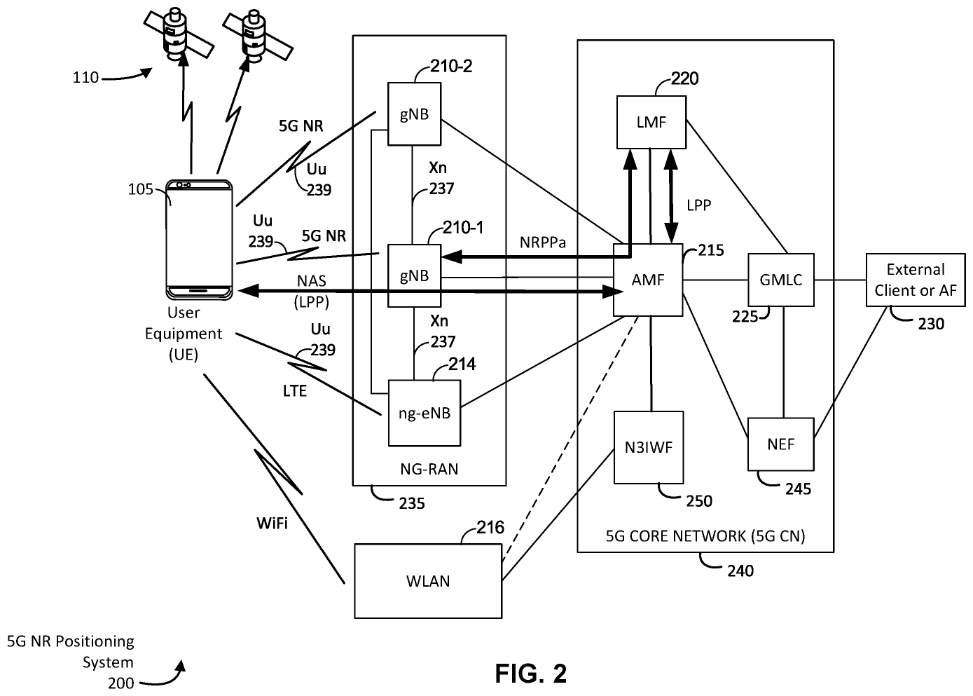

FIG. 1 is a simplified illustration of a positioning system 100 in which a UE 105, location server 160, and/or other components of the positioning system 100 can use the techniques provided herein for allocating resources for RF reference signals (e.g., radar reference signals) so as to multiplex said reference signals with data communications signals, according to various embodiments. The techniques described herein may be implemented by one or more components of the positioning system 100. The positioning system 100 can include: a UE 105; one or more satellites 110 (also referred to as space vehicles (SVs)) for a Global Navigation Satellite System (GNSS) such as the Global Positioning System (GPS), GLONASS, Galileo or Beidou; base stations 120; access points (APs) 130; location server 160; network 170; and external client 180. Generally put, the positioning system 100 can estimate a location of the UE 105 based on RF signals received by and/or sent from the UE 105 and known locations of other components (e.g., GNSS satellites 110, base stations 120, APs 130) transmitting and/or receiving the RF signals. Additional details regarding particular location estimation techniques are discussed in more detail with regard to FIGS. 2-5.

It should be noted that FIG. 1 provides only a generalized illustration of various components, any or all of which may be utilized as appropriate, and each of which may be duplicated as necessary. Specifically, although only one UE 105 is illustrated, it will be understood that many UEs (e.g., hundreds, thousands, millions, etc.) may utilize the positioning system 100. Similarly, the positioning system 100 may include a larger or smaller number of base stations 120 and/or APs 130 than illustrated in FIG. 1. The illustrated connections that connect the various components in the positioning system 100 comprise data and signaling connections which may include additional (intermediary) components, direct or indirect physical and/or wireless connections, and/or additional networks. Furthermore, components may be rearranged, combined, separated, substituted, and/or omitted, depending on desired functionality. In some embodiments, for example, the external client 180 may be directly connected to location server 160. A person of ordinary skill in the art will recognize many modifications to the components illustrated.

Depending on desired functionality, the network 170 may comprise any of a variety of wireless and/or wireline networks. The network 170 can, for example, comprise any combination of public and/or private networks, local and/or wide-area networks, and the like. Furthermore, the network 170 may utilize one or more wired and/or wireless communication technologies. In some embodiments, the network 170 may comprise a cellular or other mobile network, a wireless local area network (WLAN), a wireless wide-area network (WWAN), and/or the Internet, for example. Examples of network 170 include a Long-Term Evolution (LTE) wireless network, a Fifth Generation (5G) wireless network (also referred to as New Radio (NR) wireless network or 5G NR wireless network), a Wi-Fi WLAN, and the Internet. LTE, 5G and NR are wireless technologies defined, or being defined, by the 3rd Generation Partnership Project (3GPP). Network 170 may also include more than one network and/or more than one type of network.

The base stations 120 and access points (APs) 130 may be configured to be communicatively coupled to the network 170. In some embodiments, the base station 120s may be owned, maintained, and/or operated by a cellular network provider, and may employ any of a variety of wireless technologies, as described herein below. Depending on the technology of the network 170, a base station 120 may comprise a node B, an Evolved Node B (eNodeB or eNB), a base transceiver station (BTS), a radio base station (RBS), an NR NodeB (gNB), a Next Generation eNB (ng-eNB), or the like. A base station 120 that is a gNB or ng-eNB may be part of a Next Generation Radio Access Network (NG-RAN) which may connect to a 5G Core Network (5GC) in the case that Network 170 is a 5G network. An AP 130 may comprise a Wi-Fi AP or a Bluetooth® AP or an AP having cellular capabilities (e.g., 4G LTE and/or 5G NR), for example. Thus, UE 105 can send and receive information with network-connected devices, such as location server 160, by accessing the network 170 via a base station 120 using a first communication link 133. Additionally or alternatively, because APs 130 also may be communicatively coupled with the network 170, UE 105 may communicate with network-connected and Internet-connected devices, including location server 160, using a second communication link 135, or via one or more other UEs 145.

As used herein, the term “base station” may generically refer to a single physical transmission point, or multiple co-located physical transmission points, which may be located at a base station 120. A Transmission Reception Point (TRP) (also known as transmit/receive point) corresponds to this type of transmission point, and the term “TRP” may be used interchangeably herein with the terms “gNB,” “ng-eNB,” and “base station.” In some cases, a base station 120 may comprise multiple TRPs—e.g. with each TRP associated with a different antenna or a different antenna array for the base station 120. Physical transmission points may comprise an array of antennas of a base station 120 (e.g., as in a Multiple Input-Multiple Output (MIMO) system and/or where the base station employs beamforming). The term “base station” may additionally refer to multiple non-co-located physical transmission points, the physical transmission points may be a Distributed Antenna System (DAS) (a network of spatially separated antennas connected to a common source via a transport medium) or a Remote Radio Head (RRH) (a remote base station connected to a serving base station).

As used herein, the term “cell” may generically refer to a logical communication entity used for communication with a base station 120, and may be associated with an identifier for distinguishing neighboring cells (e.g., a Physical Cell Identifier (PCID), a Virtual Cell Identifier (VCID)) operating via the same or a different carrier. In some examples, a carrier may support multiple cells, and different cells may be configured according to different protocol types (e.g., Machine-Type Communication (MTC), Narrowband Internet-of-Things (NB-IoT), Enhanced Mobile Broadband (eMBB), or others) that may provide access for different types of devices. In some cases, the term “cell” may refer to a portion of a geographic coverage area (e.g., a sector) over which the logical entity operates.

The location server 160 may comprise a server and/or other computing device configured to determine an estimated location of UE 105 and/or provide data (e.g., “assistance data”) to UE 105 to facilitate location measurement and/or location determination by UE 105. According to some embodiments, location server 160 may comprise a Home Secure User Plane Location (SUPL) Location Platform (H-SLP), which may support the SUPL user plane (UP) location solution defined by the Open Mobile Alliance (OMA) and may support location services for UE 105 based on subscription information for UE 105 stored in location server 160. In some embodiments, the location server 160 may comprise, a Discovered SLP (D-SLP) or an Emergency SLP (E-SLP). The location server 160 may also comprise an Enhanced Serving Mobile Location Center (E-SMLC) that supports location of UE 105 using a control plane (CP) location solution for LTE radio access by UE 105. The location server 160 may further comprise a Location Management Function (LMF) that supports location of UE 105 using a control plane (CP) location solution for NR or LTE radio access by UE 105.

In a CP location solution, signaling to control and manage the location of UE 105 may be exchanged between elements of network 170 and with UE 105 using existing network interfaces and protocols and as signaling from the perspective of network 170. In a UP location solution, signaling to control and manage the location of UE 105 may be exchanged between location server 160 and UE 105 as data (e.g. data transported using the Internet Protocol (IP) and/or Transmission Control Protocol (TCP)) from the perspective of network 170.

As previously noted (and discussed in more detail below), the estimated location of UE 105 may be based on measurements of RF signals sent from and/or received by the UE 105. In particular, these measurements can provide information regarding the relative distance and/or angle of the UE 105 from one or more components in the positioning system 100 (e.g., GNSS satellites 110, APs 130, base stations 120). The estimated location of the UE 105 can be estimated geometrically (e.g., using multiangulation and/or multilateration), based on the distance and/or angle measurements, along with known position of the one or more components.

Although terrestrial components such as APs 130 and base stations 120 may be fixed, embodiments are not so limited. Mobile components may be used. For example, in some embodiments, a location of the UE 105 may be estimated at least in part based on measurements of RF signals 140 communicated between the UE 105 and one or more other UEs 145, which may be mobile or fixed. When or more other UEs 145 are used in the position determination of a particular UE 105, the UE 105 for which the position is to be determined may be referred to as the “target UE,” and each of the one or more other UEs 145 used may be referred to as an “anchor UE.” For position determination of a target UE, the respective positions of the one or more anchor UEs may be known and/or jointly determined with the target UE. Direct communication between the one or more other UEs 145 and UE 105 may comprise sidelink and/or similar Device-to-Device (D2D) communication technologies. Sidelink, which is defined by 3GPP, is a form of D2D communication under the cellular-based LTE and NR standards.

An estimated location of UE 105 can be used in a variety of applications—e.g. to assist direction finding or navigation for a user of UE 105 or to assist another user (e.g. associated with external client 180) to locate UE 105. A “location” is also referred to herein as a “location estimate”, “estimated location”, “location”, “position”, “position estimate”, “position fix”, “estimated position”, “location fix” or “fix”. The process of determining a location may be referred to as “positioning,” “position determination,” “location determination,” or the like. A location of UE 105 may comprise an absolute location of UE 105 (e.g. a latitude and longitude and possibly altitude) or a relative location of UE 105 (e.g. a location expressed as distances north or south, east or west and possibly above or below some other known fixed location (including, e.g., BS 120 or AP 130) or some other location such as a location for UE 105 at some known previous time, or a location of another UE 145). A location may be specified as a geodetic location comprising coordinates which may be absolute (e.g. latitude, longitude and optionally altitude), relative (e.g. relative to some known absolute location) or local (e.g. X, Y and optionally Z coordinates according to a coordinate system defined relative to a local area such a factory, warehouse, college campus, shopping mall, sports stadium or convention center). A location may instead be a civic location and may then comprise one or more of a street address (e.g. including names or labels for a country, state, county, city, road and/or street, and/or a road or street number), and/or a label or name for a place, building, portion of a building, floor of a building, and/or room inside a building etc. A location may further include an uncertainty or error indication, such as a horizontal and possibly vertical distance by which the location is expected to be in error or an indication of an area or volume (e.g. a circle or ellipse) within which UE 105 is expected to be located with some level of confidence (e.g. 95% confidence).

The external client 180 may be a web server or remote application that may have some association with UE 105 (e.g. may be accessed by a user of UE 105) or may be a server, application, or computer system providing a location service to some other user or users which may include obtaining and providing the location of UE 105 (e.g. to enable a service such as friend or relative finder, or child or pet location). Additionally or alternatively, the external client 180 may obtain and provide the location of UE 105 to an emergency services provider, government agency, etc.

As previously noted, the example positioning system 100 can be implemented using a wireless communication network, such as an LTE-based or 5G NR-based network. FIG. 2 shows a diagram of a 5G NR positioning system 200, illustrating an embodiment of a positioning system (e.g., positioning system 100) implementing 5G NR. The 5G NR positioning system 200 may be configured to determine the location of a UE 105 by using access nodes 210, 214, 216 (which may correspond with base stations 120 and access points 130 of FIG. 1) and (optionally) an LMF 220 (which may correspond with location server 160) to implement one or more positioning methods. Here, the 5G NR positioning system 200 comprises a UE 105, and components of a 5G NR network comprising a Next Generation (NG) Radio Access Network (RAN) (NG-RAN) 235 and a 5G Core Network (5G CN) 240. A 5G network may also be referred to as an NR network; NG-RAN 235 may be referred to as a 5G RAN or as an NR RAN; and 5G CN 240 may be referred to as an NG Core network. The 5G NR positioning system 200 may further utilize information from GNSS satellites 110 from a GNSS system like Global Positioning System (GPS) or similar system (e.g. GLONASS, Galileo, Beidou, Indian Regional Navigational Satellite System (IRNSS)). Additional components of the 5G NR positioning system 200 are described below. The 5G NR positioning system 200 may include additional or alternative components.

It should be noted that FIG. 2 provides only a generalized illustration of various components, any or all of which may be utilized as appropriate, and each of which may be duplicated or omitted as necessary. Specifically, although only one UE 105 is illustrated, it will be understood that many UEs (e.g., hundreds, thousands, millions, etc.) may utilize the 5G NR positioning system 200. Similarly, the 5G NR positioning system 200 may include a larger (or smaller) number of GNSS satellites 110, gNBs 210, ng-eNBs 214, Wireless Local Area Networks (WLANs) 216, Access and mobility Management Functions (AMF)s 215, external clients 230, and/or other components. The illustrated connections that connect the various components in the 5G NR positioning system 200 include data and signaling connections which may include additional (intermediary) components, direct or indirect physical and/or wireless connections, and/or additional networks. Furthermore, components may be rearranged, combined, separated, substituted, and/or omitted, depending on desired functionality.

The UE 105 may comprise and/or be referred to as a device, a mobile device, a wireless device, a mobile terminal, a terminal, a mobile station (MS), a Secure User Plane Location (SUPL)-Enabled Terminal (SET), or by some other name. Moreover, UE 105 may correspond to a cellphone, smartphone, laptop, tablet, personal data assistant (PDA), navigation device, Internet of Things (IoT) device, or some other portable or moveable device. Typically, though not necessarily, the UE 105 may support wireless communication using one or more Radio Access Technologies (RATs) such as using GSM, CDMA, W-CDMA, LTE, High Rate Packet Data (HRPD), IEEE 802.11 Wi-Fi®, Bluetooth, Worldwide Interoperability for Microwave Access (WiMAX™), 5G NR (e.g., using the NG-RAN 235 and 5G CN 240), etc. The UE 105 may also support wireless communication using a WLAN 216 which (like the one or more RATs, and as previously noted with respect to FIG. 1) may connect to other networks, such as the Internet. The use of one or more of these RATs may allow the UE 105 to communicate with an external client 230 (e.g., via elements of 5G CN 240 not shown in FIG. 2, or possibly via a Gateway Mobile Location Center (GMLC) 225) and/or allow the external client 230 to receive location information regarding the UE 105 (e.g., via the GMLC 225). The external client 230 of FIG. 2 may correspond to external client 180 of FIG. 1, as implemented in or communicatively coupled with a 5G NR network.

The UE 105 may include a single entity or may include multiple entities, such as in a personal area network where a user may employ audio, video and/or data I/O devices, and/or body sensors and a separate wireline or wireless modem. An estimate of a location of the UE 105 may be referred to as a location, location estimate, location fix, fix, position, position estimate, or position fix, and may be geodetic, thus providing location coordinates for the UE 105 (e.g., latitude and longitude), which may or may not include an altitude component (e.g., height above sea level, height above or depth below ground level, floor level or basement level). Alternatively, a location of the UE 105 may be expressed as a civic location (e.g., as a postal address or the designation of some point or small area in a building such as a particular room or floor). A location of the UE 105 may also be expressed as an area or volume (defined either geodetically or in civic form) within which the UE 105 is expected to be located with some probability or confidence level (e.g., 67%, 95%, etc.). A location of the UE 105 may further be a relative location comprising, for example, a distance and direction or relative X, Y (and Z) coordinates defined relative to some origin at a known location which may be defined geodetically, in civic terms, or by reference to a point, area, or volume indicated on a map, floor plan or building plan. In the description contained herein, the use of the term location may comprise any of these variants unless indicated otherwise. When computing the location of a UE, it is common to solve for local X, Y, and possibly Z coordinates and then, if needed, convert the local coordinates into absolute ones (e.g. for latitude, longitude and altitude above or below mean sea level).

Base stations in the NG-RAN 235 shown in FIG. 2 may correspond to base stations 120 in FIG. 1 and may include NR NodeB (gNB) 210-1 and 210-2 (collectively and generically referred to herein as gNBs 210). Pairs of gNBs 210 in NG-RAN 235 may be connected to one another (e.g., directly as shown in FIG. 2 or indirectly via other gNBs 210). The communication interface between base stations (gNBs 210 and/or ng-eNB 214) may be referred to as an Xn interface 237. Access to the 5G network is provided to UE 105 via wireless communication between the UE 105 and one or more of the gNBs 210, which may provide wireless communications access to the 5G CN 240 on behalf of the UE 105 using 5G NR. The wireless interface between base stations (gNBs 210 and/or ng-eNB 214) and the UE 105 may be referred to as a Uu interface 239. 5G NR radio access may also be referred to as NR radio access or as 5G radio access. In FIG. 2, the serving gNB for UE 105 is assumed to be gNB 210-1, although other gNBs (e.g. gNB 210-2) may act as a serving gNB if UE 105 moves to another location or may act as a secondary gNB to provide additional throughput and bandwidth to UE 105.

Base stations in the NG-RAN 235 shown in FIG. 2 may also or instead include a next generation evolved Node B, also referred to as an ng-eNB, 214. Ng-eNB 214 may be connected to one or more gNBs 210 in NG-RAN 235, e.g. directly or indirectly via other gNBs 210 and/or other ng-eNBs. An ng-eNB 214 may provide LTE wireless access and/or evolved LTE (eLTE) wireless access to UE 105. Some gNBs 210 (e.g. gNB 210-2) and/or ng-eNB 214 in FIG. 2 may be configured to function as positioning-only beacons which may transmit signals (e.g., Positioning Reference Signal (PRS)) and/or may broadcast assistance data to assist positioning of UE 105 but may not receive signals from UE 105 or from other UEs. It is noted that while only one ng-eNB 214 is shown in FIG. 2, some embodiments may include multiple ng-eNBs 214. Base stations 210, 214 may communicate directly with one another via an Xn communication interface. Additionally or alternatively, base stations 210, 214 may communicate directly or indirectly with other components of the 5G NR positioning system 200, such as the LMF 220 and AMF 215.

5G NR positioning system 200 may also include one or more WLANs 216 which may connect to a Non-3GPP InterWorking Function (N3IWF) 250 in the 5G CN 240 (e.g., in the case of an untrusted WLAN 216). For example, the WLAN 216 may support IEEE 802.11 Wi-Fi access for UE 105 and may comprise one or more Wi-Fi APs (e.g., APs 130 of FIG. 1). Here, the N3IWF 250 may connect to other elements in the 5G CN 240 such as AMF 215. In some embodiments, WLAN 216 may support another RAT such as Bluetooth. The N3IWF 250 may provide support for secure access by UE 105 to other elements in 5G CN 240 and/or may support interworking of one or more protocols used by WLAN 216 and UE 105 to one or more protocols used by other elements of 5G CN 240 such as AMF 215. For example, N3IWF 250 may support IPSec tunnel establishment with UE 105, termination of IKEv2/IPSec protocols with UE 105, termination of N2 and N3 interfaces to 5G CN 240 for control plane and user plane, respectively, relaying of uplink (UL) and downlink (DL) control plane Non-Access Stratum (NAS) signaling between UE 105 and AMF 215 across an N1 interface. In some other embodiments, WLAN 216 may connect directly to elements in 5G CN 240 (e.g. AMF 215 as shown by the dashed line in FIG. 2) and not via N3IWF 250. For example, direct connection of WLAN 216 to 5GCN 240 may occur if WLAN 216 is a trusted WLAN for 5GCN 240 and may be enabled using a Trusted WLAN Interworking Function (TWIF) (not shown in FIG. 2) which may be an element inside WLAN 216. It is noted that while only one WLAN 216 is shown in FIG. 2, some embodiments may include multiple WLANs 216.

Access nodes may comprise any of a variety of network entities enabling communication between the UE 105 and the AMF 215. This can include gNBs 210, ng-eNB 214, WLAN 216, and/or other types of cellular base stations. However, access nodes providing the functionality described herein may additionally or alternatively include entities enabling communications to any of a variety of RATs not illustrated in FIG. 2, which may include non-cellular technologies. Thus, the term “access node,” as used in the embodiments described herein below, may include but is not necessarily limited to a gNB 210, ng-eNB 214 or WLAN 216.

In some embodiments, an access node, such as a gNB 210, ng-eNB 214, or WLAN 216 (alone or in combination with other components of the 5G NR positioning system 200), may be configured to, in response to receiving a request for location information from the LMF 220, obtain location measurements of uplink (UL) signals received from the UE 105) and/or obtain downlink (DL) location measurements from the UE 105 that were obtained by UE 105 for DL signals received by UE 105 from one or more access nodes. As noted, while FIG. 2 depicts access nodes 210, 214, and 216 configured to communicate according to 5G NR, LTE, and Wi-Fi communication protocols, respectively, access nodes configured to communicate according to other communication protocols may be used, such as, for example, a Node B using a Wideband Code Division Multiple Access (WCDMA) protocol for a Universal Mobile Telecommunications Service (UMTS) Terrestrial Radio Access Network (UTRAN), an eNB using an LTE protocol for an Evolved UTRAN (E-UTRAN), or a Bluetooth® beacon using a Bluetooth protocol for a WLAN. For example, in a 4G Evolved Packet System (EPS) providing LTE wireless access to UE 105, a RAN may comprise an E-UTRAN, which may comprise base stations comprising eNBs supporting LTE wireless access. A core network for EPS may comprise an Evolved Packet Core (EPC). An EPS may then comprise an E-UTRAN plus an EPC, where the E-UTRAN corresponds to NG-RAN 235 and the EPC corresponds to 5GCN 240 in FIG. 2. The methods and techniques described herein for obtaining a civic location for UE 105 may be applicable to such other networks.

The gNBs 210 and ng-eNB 214 can communicate with an AMF 215, which, for positioning functionality, communicates with an LMF 220. The AMF 215 may support mobility of the UE 105, including cell change and handover of UE 105 from an access node 210, 214, or 216 of a first RAT to an access node 210, 214, or 216 of a second RAT. The AMF 215 may also participate in supporting a signaling connection to the UE 105 and possibly data and voice bearers for the UE 105. The LMF 220 may support positioning of the UE 105 using a CP location solution when UE 105 accesses the NG-RAN 235 or WLAN 216 and may support position procedures and methods, including UE assisted/UE based and/or network based procedures/methods, such as Assisted GNSS (A-GNSS), Observed Time Difference Of Arrival (OTDOA) (which may be referred to in NR as Time Difference Of Arrival (TDOA)), Real Time Kinematic (RTK), Precise Point Positioning (PPP), Differential GNSS (DGNSS), Enhance Cell ID (ECID), angle of arrival (AoA), angle of departure (AoD), WLAN positioning, round trip signal propagation delay (RTT), multi-cell RTT, and/or other positioning procedures and methods. The LMF 220 may also process location service requests for the UE 105, e.g., received from the AMF 215 or from the GMLC 225. The LMF 220 may be connected to AMF 215 and/or to GMLC 225. In some embodiments, a network such as 5GCN 240 may additionally or alternatively implement other types of location-support modules, such as an Evolved Serving Mobile Location Center (E-SMLC) or a SUPL Location Platform (SLP). It is noted that in some embodiments, at least part of the positioning functionality (including determination of a UE 105's location) may be performed at the UE 105 (e.g., by measuring downlink PRS (DL-PRS) signals transmitted by wireless nodes such as gNBs 210, ng-eNB 214 and/or WLAN 216, and/or using assistance data provided to the UE 105, e.g., by LMF 220).

The Gateway Mobile Location Center (GMLC) 225 may support a location request for the UE 105 received from an external client 230 and may forward such a location request to the AMF 215 for forwarding by the AMF 215 to the LMF 220. A location response from the LMF 220 (e.g., containing a location estimate for the UE 105) may be similarly returned to the GMLC 225 either directly or via the AMF 215, and the GMLC 225 may then return the location response (e.g., containing the location estimate) to the external client 230.

A Network Exposure Function (NEF) 245 may be included in 5GCN 240. The NEF 245 may support secure exposure of capabilities and events concerning 5GCN 240 and UE 105 to the external client 230, which may then be referred to as an Access Function (AF) and may enable secure provision of information from external client 230 to 5GCN 240. NEF 245 may be connected to AMF 215 and/or to GMLC 225 for the purposes of obtaining a location (e.g. a civic location) of UE 105 and providing the location to external client 230.

As further illustrated in FIG. 2, the LMF 220 may communicate with the gNBs 210 and/or with the ng-eNB 214 using an NR Positioning Protocol annex (NRPPa) as defined in 3GPP Technical Specification (TS) 38.455. NRPPa messages may be transferred between a gNB 210 and the LMF 220, and/or between an ng-eNB 214 and the LMF 220, via the AMF 215. As further illustrated in FIG. 2, LMF 220 and UE 105 may communicate using an LTE Positioning Protocol (LPP) as defined in 3GPP TS 37.355. Here, LPP messages may be transferred between the UE 105 and the LMF 220 via the AMF 215 and a serving gNB 210-1 or serving ng-eNB 214 for UE 105. For example, LPP messages may be transferred between the LMF 220 and the AMF 215 using messages for service-based operations (e.g., based on the Hypertext Transfer Protocol (HTTP)) and may be transferred between the AMF 215 and the UE 105 using a 5G NAS protocol. The LPP protocol may be used to support positioning of UE 105 using UE assisted and/or UE based position methods such as A-GNSS, RTK, TDOA, multi-cell RTT, AoD, and/or ECID. The NRPPa protocol may be used to support positioning of UE 105 using network based position methods such as ECID, AoA, uplink TDOA (UL-TDOA) and/or may be used by LMF 220 to obtain location related information from gNBs 210 and/or ng-eNB 214, such as parameters defining DL-PRS transmission from gNBs 210 and/or ng-eNB 214.

In the case of UE 105 access to WLAN 216, LMF 220 may use NRPPa and/or LPP to obtain a location of UE 105 in a similar manner to that just described for UE 105 access to a gNB 210 or ng-eNB 214. Thus, NRPPa messages may be transferred between a WLAN 216 and the LMF 220, via the AMF 215 and N3IWF 250 to support network-based positioning of UE 105 and/or transfer of other location information from WLAN 216 to LMF 220. Alternatively, NRPPa messages may be transferred between N3IWF 250 and the LMF 220, via the AMF 215, to support network-based positioning of UE 105 based on location related information and/or location measurements known to or accessible to N3IWF 250 and transferred from N3IWF 250 to LMF 220 using NRPPa. Similarly, LPP and/or LPP messages may be transferred between the UE 105 and the LMF 220 via the AMF 215, N3IWF 250, and serving WLAN 216 for UE 105 to support UE assisted or UE based positioning of UE 105 by LMF 220.

In a 5G NR positioning system 200, positioning methods can be categorized as being “UE assisted” or “UE based.” This may depend on where the request for determining the position of the UE 105 originated. If, for example, the request originated at the UE (e.g., from an application, or “app,” executed by the UE), the positioning method may be categorized as being UE based. If, on the other hand, the request originates from an external client or AF 230, LMF 220, or other device or service within the 5G network, the positioning method may be categorized as being UE assisted (or “network-based”).

With a UE-assisted position method, UE 105 may obtain location measurements and send the measurements to a location server (e.g., LMF 220) for computation of a location estimate for UE 105. For RAT-dependent position methods location measurements may include one or more of a Received Signal Strength Indicator (RSSI), Round Trip signal propagation Time (RTT), Reference Signal Received Power (RSRP), Reference Signal Received Quality (RSRQ), Reference Signal Time Difference (RSTD), Time of Arrival (TOA), AoA, Receive Time-Transmission Time Difference (Rx-Tx), Differential AoA (DAoA), AoD, or Timing Advance (TA) for gNBs 210, ng-eNB 214, and/or one or more access points for WLAN 216. Additionally or alternatively, similar measurements may be made of sidelink signals transmitted by other UEs, which may serve as anchor points for positioning of the UE 105 if the positions of the other UEs are known. The location measurements may also or instead include measurements for RAT-independent positioning methods such as GNSS (e.g., GNSS pseudorange, GNSS code phase, and/or GNSS carrier phase for GNSS satellites 110), WLAN, etc.

With a UE-based position method, UE 105 may obtain location measurements (e.g., which may be the same as or similar to location measurements for a UE assisted position method) and may further compute a location of UE 105 (e.g., with the help of assistance data received from a location server such as LMF 220, an SLP, or broadcast by gNBs 210, ng-eNB 214, or WLAN 216).

With a network based position method, one or more base stations (e.g., gNBs 210 and/or ng-eNB 214), one or more APs (e.g., in WLAN 216), or N3IWF 250 may obtain location measurements (e.g., measurements of RSSI, RTT, RSRP, RSRQ, AoA, or TOA) for signals transmitted by UE 105, and/or may receive measurements obtained by UE 105 or by an AP in WLAN 216 in the case of N3IWF 250, and may send the measurements to a location server (e.g., LMF 220) for computation of a location estimate for UE 105.

Positioning of the UE 105 also may be categorized as UL, DL, or DL-UL based, depending on the types of signals used for positioning. If, for example, positioning is based solely on signals received at the UE 105 (e.g., from a base station or other UE), the positioning may be categorized as DL based. On the other hand, if positioning is based solely on signals transmitted by the UE 105 (which may be received by a base station or other UE, for example), the positioning may be categorized as UL based. Positioning that is DL-UL based includes positioning, such as RTT-based positioning, that is based on signals that are both transmitted and received by the UE 105. Sidelink (SL)-assisted positioning comprises signals communicated between the UE 105 and one or more other UEs. According to some embodiments, UL, DL, or DL-UL positioning as described herein may be capable of using SL signaling as a complement or replacement of SL, DL, or DL-UL signaling.

Depending on the type of positioning (e.g., UL, DL, or DL-UL based) the types of reference signals used can vary. For DL-based positioning, for example, these signals may comprise PRS (e.g., DL-PRS transmitted by base stations or SL-PRS transmitted by other UEs), which can be used for TDOA, AoD, and RTT measurements. Other reference signals that can be used for positioning (UL, DL, or DL-UL) may include Sounding Reference Signal (SRS), Channel State Information Reference Signal (CSI-RS), synchronization signals (e.g., synchronization signal block (SSB) Synchronizations Signal (SS)), Physical Uplink Control Channel (PUCCH), Physical Uplink Shared Channel (PUSCH), Physical Sidelink Shared Channel (PSSCH), Demodulation Reference Signal (DMRS), etc. Moreover, reference signals may be transmitted in a Tx beam and/or received in an Rx beam (e.g., using beamforming techniques), which may impact angular measurements, such as AoD and/or AoA.

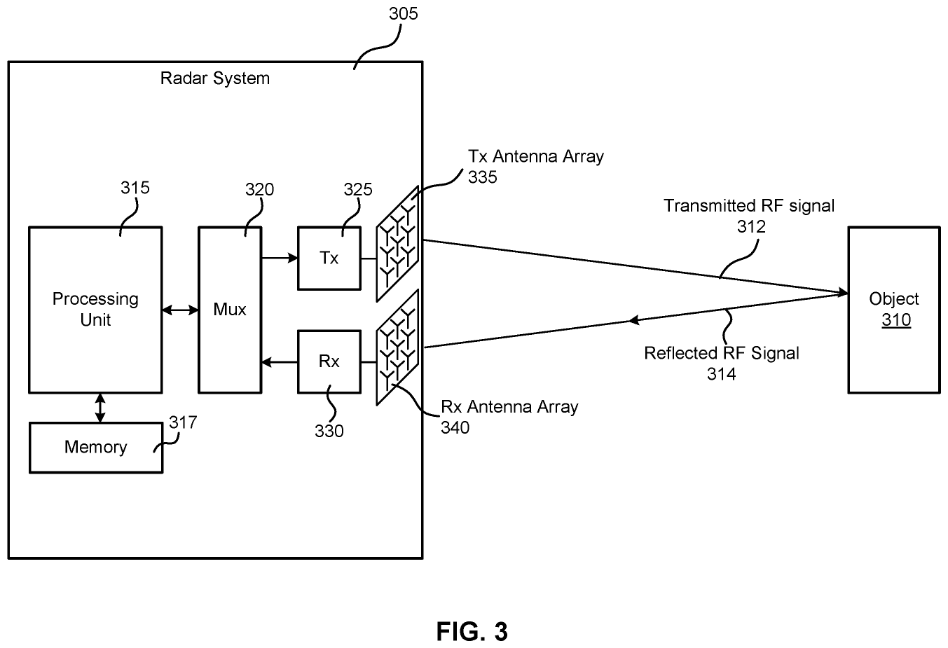

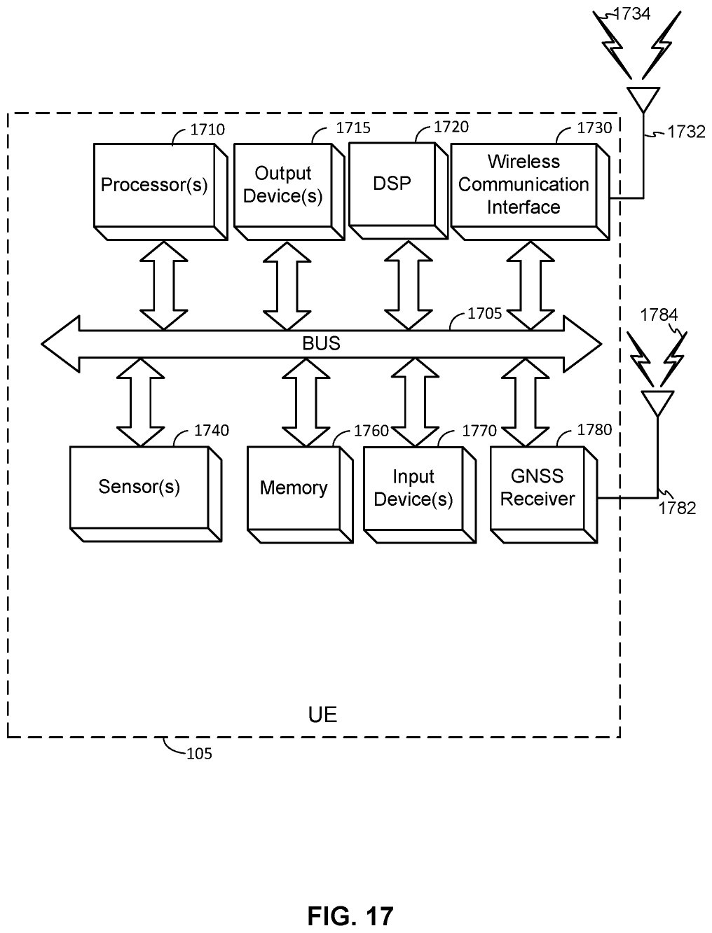

FIG. 3 is a block diagram of a radar system 305 performing radar-based directional proximity sensing, according to an embodiment. As used herein, the terms “waveform” and “sequence” and derivatives thereof are used interchangeably to refer to RF signals generated by a transmitter of the radar system and received by a receiver of the radar system for object detection. A “pulse” and derivatives thereof are generally referred to herein as waveforms comprising a sequence or complementary pair of sequences transmitted and received to generate a CIR. The radar system 305 may comprise a standalone device or may be integrated into a larger electronic device, such as a mobile phone or other device. (Example components of such an electronic device are illustrated in FIG. 17 and discussed in detail hereafter.)

With regard to the functionality of the radar system 305 in FIG. 3, the radar system 305 can detect the proximity of an object 310 by generating a series of transmitted RF signals 312 (comprising one or more pulses). Some of these transmitted RF signals 312 reflect off of the object 310, and these reflected RF signals 314 are then processed by the radar system 305 using BF and DSP techniques (including leakage cancellation) to determine the object's location (azimuth, elevation, velocity, and range) relative to the radar system 305. Because embodiments may implement a flexible FOV, the radar system 305 can detect an object 310 within a select volume of space. This volume of space can be defined by a range of azimuths, elevations, and distances from the radar system 305. (As described below, this volume of space may also be defined by an FOV (a range of azimuths and elevations) and a range of distances within the FOV or from an area of interest corresponding to the FOV.)

To enable radar proximity detecting radar system 305 includes a processing unit 315, memory 317, multiplexer (mux) 320, Tx processing circuitry 325, and Rx processing circuitry 330. The radar system 305 may include additional components not illustrated, such as a power source, user interface, or electronic interface. It can be noted, however, that these components of the radar system 305 may be rearranged or otherwise altered in alternative embodiments, depending on desired functionality. Moreover, as used herein, the terms “transmit circuitry” or “Tx circuitry” refer to any circuitry utilized to create and/or transmit the transmitted RF signal 312. Likewise, the terms “receive circuitry” or “Rx circuitry” refer to any circuitry utilized to detect and/or process the reflected RF signal 314. As such, “transmit circuitry” and “receive circuitry” may not only comprise the Tx processing circuitry 325 and Rx processing circuitry 330 respectively, but may also comprise the mux 320 and processing unit 315. In some embodiments, the processing unit may compose at least part of a modem and/or wireless communications interface. In some embodiments, more than one processing unit may be used to perform the functions of the processing unit 315 described herein.

The Tx processing circuitry 325 and Rx circuitry 330 may comprise subcomponents for respectively generating and detecting RF signals. As a person of ordinary skill in the art will appreciate, the Tx processing circuitry 325 may therefore include a pulse generator, digital-to-analog converter (DAC), a mixer (for up-mixing the signal to the transmit frequency), one or more amplifiers (for powering the transmission via Tx antenna array 335), etc. The Rx processing circuitry 330 may have similar hardware for processing a detected RF signal. In particular, the Rx processing circuitry 330 may comprise an amplifier (for amplifying a signal received via Rx antenna 340), a mixer for down-converting the received signal from the transmit frequency, an analog-to-digital converter (ADC) for digitizing the received signal, and a pulse correlator providing a matched filter for the pulse generated by the Tx processing circuitry 325. The Rx processing circuitry 330 may therefore use the correlator output as the CIR, which can be processed by the processing unit 315 (or other circuitry) for leakage cancellation as described herein. Other processing of the CTR may also be performed, such as object detecting, range, speed, or direction of arrival (DoA) estimation.

BF is further enabled by a Tx antenna array 335 and Rx antenna array 340. Each antenna array 335, 340 comprises a plurality of antenna elements. It can be noted that, although the antenna arrays 335, 340 of FIG. 3 include two-dimensional arrays, embodiments are not so limited. Arrays may simply include a plurality of antenna elements along a single dimension that provides for spatial cancellation between the Tx and Rx sides of the radar system 305. As a person of ordinary skill in the art will appreciate, the relative location of the Tx and Rx sides, in addition to various environmental factors can impact how spatial cancellation may be performed.

It can be noted that the properties of the transmitted RF signal 312 may vary, depending on the technologies utilized. Techniques provided herein can apply generally to “mmWave” technologies, which typically operate at 57-71 GHz, but may include frequencies ranging from 30-300 GHz. This includes, for example, frequencies utilized by the 802.11ad Wi-Fi standard (operating at 60 GHz). That said, some embodiments may utilize radar with frequencies outside this range. For example, in some embodiments, 5G frequency bands (e.g., 28 GHz) may be used. Because radar may be performed in the same busy bands as communication, hardware may be utilized for both communication and radar sensing, as previously noted. For example, one or more of the components of the radar system 305 shown in FIG. 3 may be included in a wireless modem (e.g., Wi-Fi or 5G modem). Additionally, techniques may apply to RF signals comprising any of a variety of pulse types, including compressed pulses (e.g., comprising Chirp, Golay, Barker, or Ipatov sequences) may be utilized. That said, embodiments are not limited to such frequencies and/or pulse types. Additionally, because the radar system may be capable of sending RF signals for communication (e.g., using 802.11 communication technology), embodiments may leverage channel estimation used in communication for performing proximity detection as provided herein. Accordingly, the pulses may be the same as those used for channel estimation in communication.

As noted, the radar system 305 may be integrated into an electronic device in which proximity detecting is desired. For example, the radar system 305, which can perform radar-based proximity detecting, may be part of communication hardware found in modern mobile phones. Other devices, too, may utilize the techniques provided herein. These can include, for example, other mobile devices (e.g., tablets, portable media players, laptops, wearable devices, virtual reality (VR) devices, augmented reality (AR) devices), as well as other electronic devices (e.g., security devices, on-vehicle systems). That said, electronic devices into which a radar system 305 may be integrated are not limited to mobile devices. Furthermore, radar-based proximity sensing as described herein may be performed by a radar system 305 that may not be otherwise used in wireless communication.

Although capable of providing a high degree of accuracy, directional proximity sensing shown in FIG. 3, if performed frequently, can be problematic in certain applications. For example, to perform a scan for a nearby object 310 the radar system 305 may transmit a large number of transmitted RF signals 312 such that each antenna element in the Rx antenna array 340 receives a reflected RF signal 314 corresponding to a transmitted RF signal 312 transmitted from each antenna element in the Tx antenna array 335. Moreover, the radar system 305 may perform a scan very frequently (e.g., several times per second). And thus, the directional proximity sensing performed by the radar system 305 may consume a large amount of power. This may be problematic for low-power applications.

According to embodiments described herein, radar-based directional proximity sensing techniques can be implemented to help reduce the power consumption used in directional radar sensing. In particular, according to some embodiments, a radar system can first operate in a low-power, omnidirectional proximity sensing mode in which signals are transmitted having no directionality. Once an object is detected, the radar system can then operate in a higher-power directional proximity sensing mode to provide accurate directional detection capabilities in the desired FOV.

The above-described radar-based sensing techniques may be described as a “monostatic” radar system, in which the transmitter 325 and receiver 330 are collocated. In contrast, a monostatic radar may be distinguished from a bistatic or multi-static radar system, described below.

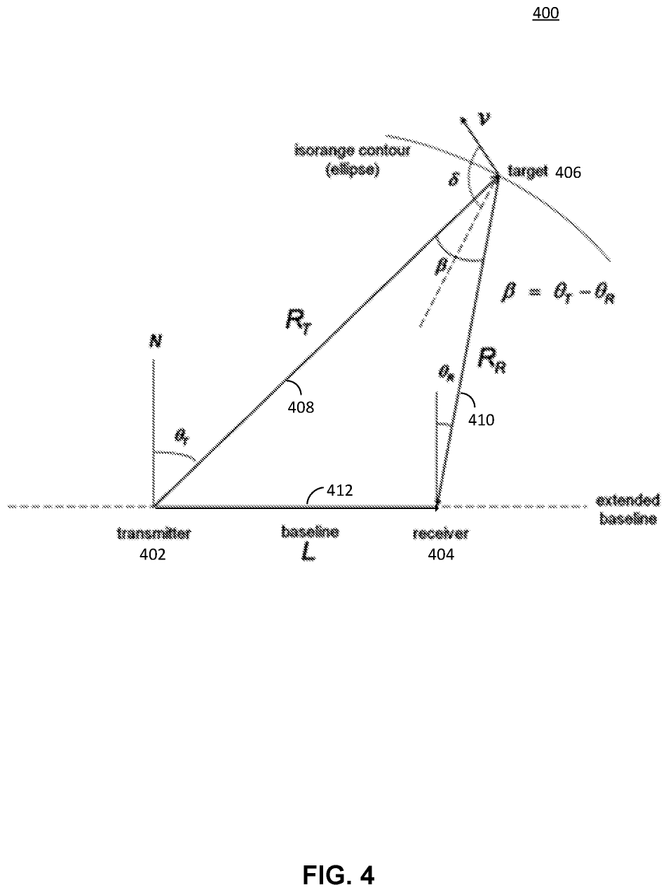

FIG. 4 is a simplified diagram showing the basic operation of a bistatic radar system 400. A transmitter 402 and a receiver 404 are used to send and receive radar signals for sensing a target 406. While a bistatic radar example is shown, the same principals of operation can be applied to a multi-static radar, which utilizes more than two transmitter(s)/receiver(s). For example, a multi-static radar may utilize one transmitter and two receivers. In another example, a multi-static radar may utilize two transmitters and one receiver. Larger numbers of transmitters and/or receivers may also be possible.

In bistatic radar system 400, the transmitter 402 sends a transmit signal 408 which traverses a distance R_{T} to reach target 406. The transmit signal 408 reflects from the target 406 and becomes an echo signal 410 which traverses a distance R_{R} to reach the receiver 404. A primary function served by bistatic radar system 400 is sensing the range, or distance R_{R}, from the target 406 to the receiver 404. The system determines the range R_{R} primary by sensing the amount of time taken for the transmit signal 408 and echo signal 410 to traverse the total distance Rₛᵤₘ, which is the sum of R_{T} and R_{R}:

$${R}_{sum} = {R}_{T} + {R}_{R} \qquad ( Eq . 1 )$$

The total distance Rₛᵤₘ defines an ellipsoid surface (also known as the iso-range contour) with foci at the locations of the transmitter 402 and the receiver 404, respectively. The ellipsoid surface represents all the possible locations of the target 406, given the total distance Rₛᵤₘ. The radar system 400 is capable of measuring the distance Rₛᵤₘ. For example, if perfect synchronization of timing between the transmitter 402 and the receiver 404 can be assumed, it would be easy to simply measure the time duration Tₛᵤₘ between moment when the transmitter 402 sent the transmit signal 408 and moment when the receiver 404 received the echo signal 410. Multiplying the time duration Tₛᵤₘ by the speed of the signal through free space, e.g., approximately c=3*10⁸ meters/second, would yield Rₛᵤₘ. Thus, the ellipsoid surface of all possible locations of the target 406 can be found by measuring the “flight time” Tₛᵤₘ of the bistatic radar signal.

According to some embodiments, the distance Rum can be measured without tight time synchronization between the transmitter 402 and the receiver 404. In one embodiment, a line-of-sight (LOS) signal 412 can be sent from the transmitter 402 to the receiver 404. That is, at the same time that transmitter 402 sends the transmit signal 408 toward the target 406, transmitter 402 may also send the LOS signal 412 toward the receiver 404. According to a specific embodiment, the transmit signal 408 may correspond to a main lobe of a transmit antenna beam pattern emitted from the transmitter 402, while the LOS signal 412 corresponds to a side lobe of the same transmit antenna beam pattern emitted from transmitter 402.

The receiver 404 receives both the echo signal 410 and the LOS signal 412 and can utilize the timing of the reception of these two signals to measure the total distance Rₛᵤₘ, using the expression:

$${R}_{sum} = ( {T}_{Rx \_ echo} - {T}_{{Rx}_{LOS}} ) * c + L \qquad ( Eq . 2 )$$

Here, T_{Rx_echo} is the time of reception of the echo signal 410. T_{RxLOS} is the time of reception of the LOS signal 412. As mentioned, c=3*10⁸ meters/second is the speed of the signal through free space. L is the distance between the transmitter 402 and the receiver 404. Once Rₛᵤₘ is found, it can be used to calculate the target range R_{R}, i.e., the distance between the target 406 and the receiver 404, using the following expression:

$${R}_{R} = \frac{{R}_{sum}^{2} - {L}^{2}}{2 ( {R}_{sum} + L * sin {θ}_{R} )} \qquad ( Eq . 3 )$$

The bistatic radar system 400 can also be used to determine the angle of arrival (AoA) θ_{R} at which the echo signal 410 is received by receiver 404. This can be done in various ways. One way is to estimate θ_{R} by using an antenna array at the receiver 404. An antenna array, which comprises multiple antenna elements, can be operated as a programmable directional antenna capable of sensing the angle at which a signal is received. Thus, the receiver 404 may employ an antenna array to sense the angle of arrival of the echo signal 410. Another way to estimate θ_{R} involves multilateration. Multilateration refers to the determination of the intersection of two or more curves or surfaces that represent possible locations of a target. For example, the bistatic radar system 400 shown in FIG. 4 can define a first ellipsoid surface representing possible locations of the target 406, as described previously. A second bistatic radar system with a differently located transmitter and/or receiver can define a second, different ellipsoid surface that also represents the possible locations of the target 406. The intersection of the first ellipsoid surface and the second ellipsoid surface can narrow down the possible location(s) of the target 406. In three-dimensional space, four such ellipsoid surfaces would generally be needed to reduce the possible location to a single point, thus identifying the location of target 406. In two-dimensional space (e.g., assuming all transmitters, receivers, and the targets are confined to the being on the ground), three such ellipsoid surfaces (for two-dimensional space, the ellipsoid surfaces reduce to elliptical curves) would generally be needed to reduce the possible locations to a single point, thus identifying the location of target 406. Multilateration can also be achieved in a similar manner using multi-static radar system instead of multiple bistatic radar systems.

Furthermore, the bistatic radar system 400 can also be used to determine the Doppler frequency associated with the target 406. The Doppler frequency denotes the relative velocity of the target 406, from the perspective of the receiver 404—i.e., the velocity at which the target 406 is approaching/going away from the receiver 404. For a stationary transmitter 402 and a stationary receiver 404, the Doppler frequency of the target 406 can be calculated as:

$${f}_{D} = \frac{2 v}{c} * cos δ * cos ( β / 2 ) \qquad ( Eq . 4 )$$

Here, f_{D} is the Doppler frequency, v is the velocity of the target 406 relative to a fixed frame of reference defined by the stationary transmitter 402 and receiver 404. β is the angle formed between the transmit signal 408 and the echo signal 410 at the target 406. δ is the angle between the velocity vector v and the center ray (half angle) defined within angle β.

In FIG. 4, a fixed frame of reference is defined with respect to the stationary transmitter 402 and stationary receiver 404. Specifically, a baseline of length L can be drawn between the transmitter 402 and the receiver 404. The baseline can be extended beyond the transmitter 402 and receiver 404. One or more normal lines can be drawn as being perpendicular to the baseline. A transmit angle θ_{T} can be defined relative to a normal line drawn from the location of the transmitter 402. A receive angle θ_{R}, referred to above as the angle of arrival, can be defined relative to a normal line drawn from the location of the receiver 404.

As mentioned previously, bistatic radar system 400 can be operated to sense a target in two-dimensional space or three-dimensional space. An additional degree of freedom is introduced in the case of three-dimensional space. However, the same basic principles apply, and analogous calculations may be performed.

FIG. 5 illustrates the implementation of the bistatic radar system in a wireless communications system, according to an embodiment of the disclosure. The wireless communications system may comprise a cellular communication system 500, as shown in FIG. 5. The cellular communications system 500 may comprise numerous Transmission Reception Points (TRPs), which provide transmission and/or reception of signals with other devices. Examples of TRPs within the cellular communications system 500 include base stations 502 and 504, which serve to provide cellular communications for user equipment (UE) such as vehicles, wireless phones, wearable device, personal access points, and a plethora of other types of user devices in the vicinity that require wireless data communications. For instance, base stations 502 and 504 may be configured to support data communications with a UE device, by transmitting data symbols to or receiving data symbols from the UE device. Resources within the cellular communication system 500, such as base station 502 and 504, may thus be utilized to serve “double duty” to support not only cellular communication operations but also bistatic and/or multi-static radar operations.

For example, base stations 502 and base station 504 may serve as the transmitter 402 and receiver 404, respectively, of the bistatic radar system 400 shown in FIG. 4. Base station 502 may transmit the transmit signal 508, which reflects from target 406 and becomes the echo signal 510 received by the base stations 504. The base station 504 may also receive a line-of-sight (LOS) signal 512 from the base station 502. By receiving both the LOS signal 512 and the echo signal 510, the RX base station 504 can measure the value associated with the time difference between the reception times T_{Rx_echo} and T_{RxLOS} associated with the reception of the echo signal 510 and the LOS signal 512, respectively. For example, the RX base station 504 may cross-correlate the received LOS signal 512 with the received echo signal 510, such as by mixing the two signals in analog or digital form, to yield a value representative of the time difference (T_{Rx_echo}−T_{RxLOS}). The time difference can be used to find the total distance Rₛᵤₘ. The total distance Rₛᵤₘ can then be used to define an ellipsoid surface, which along with other information may be used to find the target range R_{R}, angle of arrival (AoA) θ_{R}, and/or Doppler frequency associated with the target 506, using one or more techniques discussed previously with respect to FIG. 1.

Here, target 406 may be, but does not have to be, a UE that is being supported by the cellular communications system 500. In some instances, target 406 may be a UE that is configured to transmit and receive wireless signals carrying voice, text, and/or wireless data using the base stations of cellular communications system 500. In other instances, target 406 may simply be a remote object that is within the bistatic radar range of base station 502 and base station 504 but otherwise has nothing to do with the cellular communications functions of system 500.

In the bistatic example shown in FIG. 5, the transmitter is referred to as the TX base station 502, and the receiver is referred to as the RX base station 504. More generally, TX base station 502 may be referred to as a TX TRP, and RX base station 504 may be referred to as a RX TRP. Here “TX” and “RX” merely refer to the fact that base station 502 is used to transmit the radar transmission signal 508, and the base station 504 is used to receive the radar echo signal 510. The terms “TX” and “RX” in this context do not limit the operation of the base stations 502 and 504 to serve other functions, e.g., to serve as transmitter and/or receiver in other bistatic or multi-static radar operations (beyond what is illustrated in FIG. 1) or as base stations transmitting and receiving data communications in the normal operation of the cellular communications system 500. While FIG. 5 illustrates a simple bistatic radar system, a multi-static radar system may also be implemented within a cellular communications system in a similar manner. Also, while FIG. 5 illustrates a simple example in two-dimensional space, the same operations can be extended to three-dimensional space.

Implementing a bistatic or multi-static radar system within a cellular communications system according to embodiments of the present disclosure may yield numerous benefits. One particular benefit is the flexible utilization of bandwidth allocated for cellular communications. For example, according to one embodiment, the cellular communications system 500 may conform to the “5G” standard introduced in the release 15 version of the 3rd Generation Partnership Project (3GPP) specifications. Ever increasing bandwidth allotted to present and future cellular communications systems, including 5G and 5G beyond, may be leveraged for the transmission of bistatic and multi-static radar signals. Thus, radio frequency (RF) sensing (e.g. radar) may be enabled by utilizing available cellular RF spectrum resource. For example, one or more of the transmit signal 508, echo signal 510, and/or LOS signal 512 may occupy bandwidth within a portion of radio frequency (RF) spectrum allocated to the cellular communications system 500 for data communications.

Also, the inherent benefits of bistatic and multi-static radar systems can be realized by an existing, widespread network of well-positioned transmitters and receivers, in the form of cellular base stations. Compared with a monostatic radar system, a bistatic or multi-static radar system mitigates against self-interference by having physically separated transmitter equipment and receiver equipment. Cellular base stations, such as base stations 502 and 504 shown in FIG. 5, already exist and cover vast geographic areas where users, vehicles, and other objects of interest are likely to appear. Such cellular base stations are well-dispersed, and as a result, provide opportunities for the selection of appropriately located base stations to serve as transmitters and receivers for bistatic and multi-static radar operations.

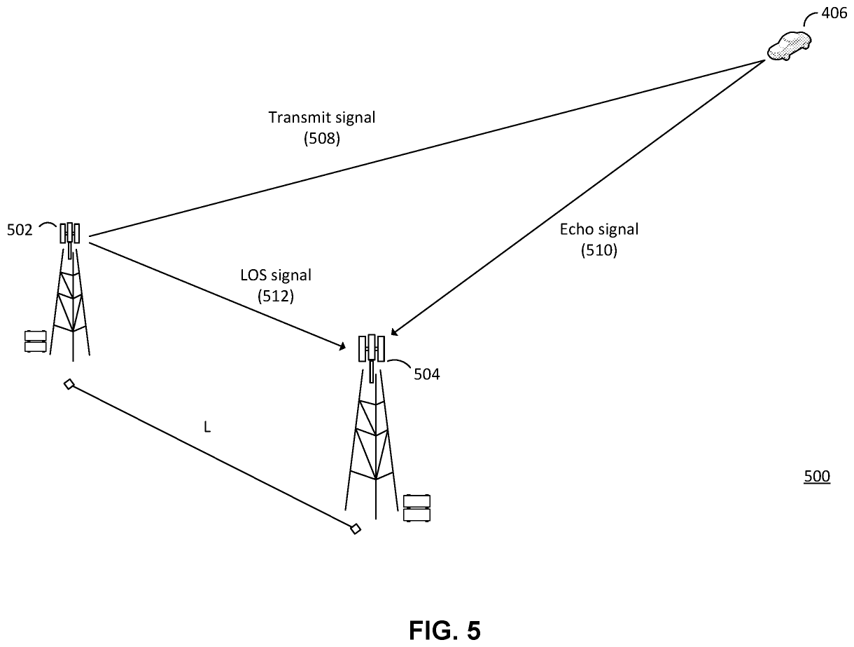

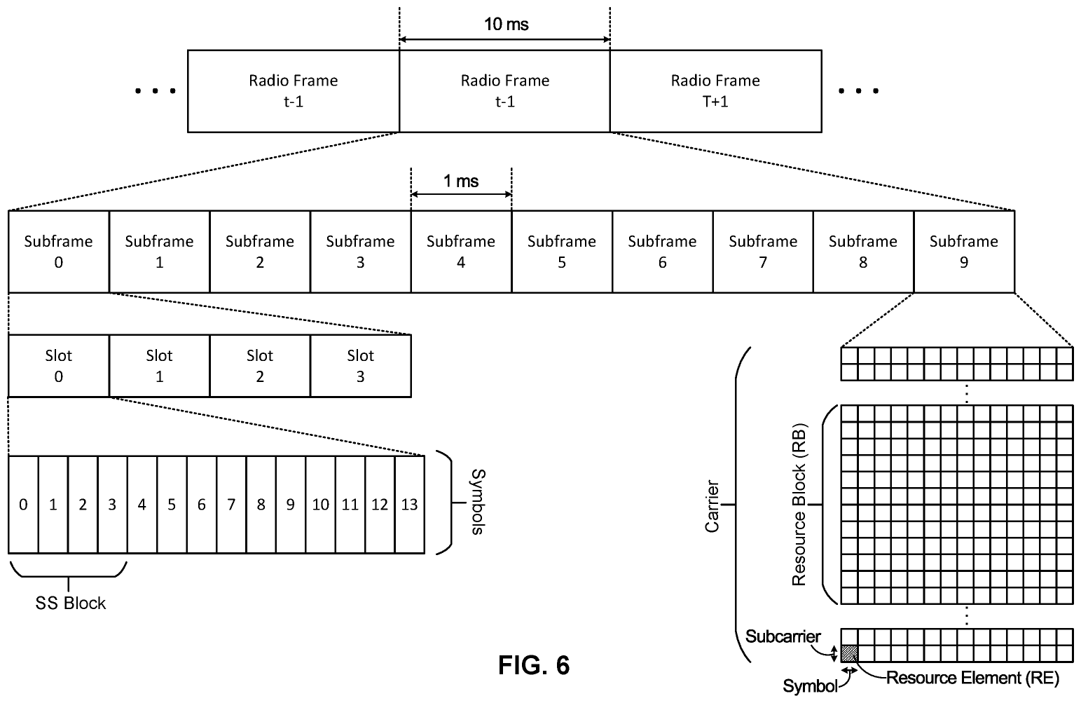

FIG. 6 is a diagram showing an example of a frame structure for NR and associated terminology, which can serve as the basis for physical layer communication between the UE 105 and base stations/TRPs. The transmission timeline for each of the downlink and uplink may be partitioned into units of radio frames. Each radio frame may have a predetermined duration (e.g., 10 ms) and may be partitioned into 10 subframes, each of 1 ms, with indices of 0 through 9. Each subframe may include a variable number of slots depending on the subcarrier spacing. Each slot may include a variable number of symbol periods (e.g., 7 or 14 symbols) depending on the subcarrier spacing. The symbol periods in each slot may be assigned indices. A mini slot may comprise a sub slot structure (e.g., 2, 3, or 4 symbols). Additionally shown in FIG. 6 is the complete Orthogonal Frequency-Division Multiplexing (OFDM) of a subframe, showing how a subframe can be divided across both time and frequency into a plurality of Resource Blocks (RBs). A single RB can comprise a grid of Resource Elements (REs) spanning 14 symbols and 12 subcarriers.

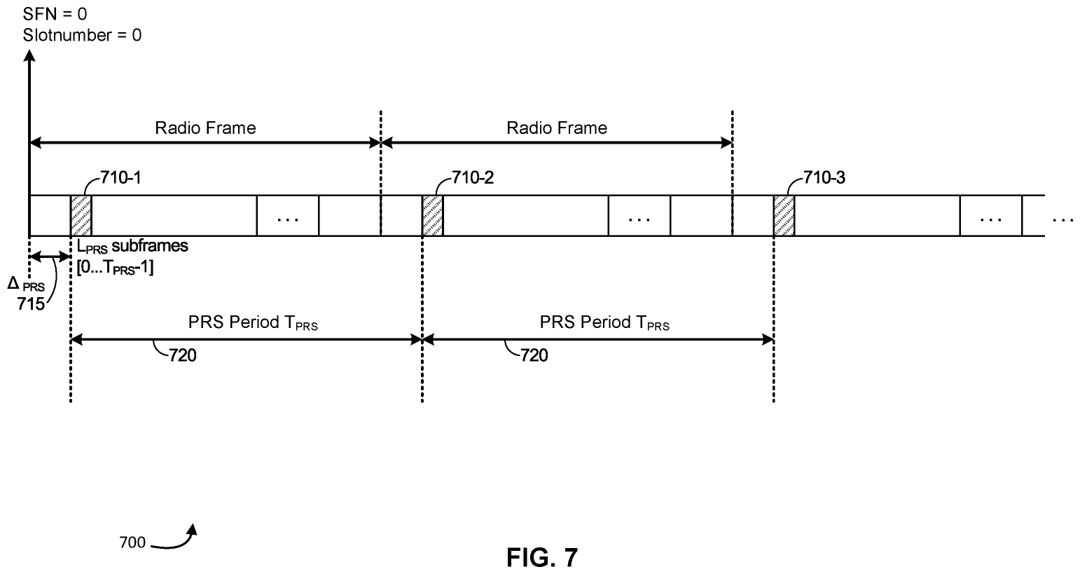

Each symbol in a slot may indicate a link direction (e.g., downlink (DL), uplink (UL), or flexible) or data transmission and the link direction for each subframe may be dynamically switched. The link directions may be based on the slot format. Each slot may include DL/UL data as well as DL/UL control information. In NR, a synchronization signal (SS) block is transmitted. The SS block includes a primary SS (PSS), a secondary SS (SSS), and a two symbol Physical Broadcast Channel (PBCH). The SS block can be transmitted in a fixed slot location, such as the symbols 0-3 as shown in FIG. 6. FIG. 7 further illustrates and describes the components of the SS block. The PSS and SSS may be used by UEs for cell search and acquisition. The PSS may provide half-frame timing, the SS may provide the cyclic prefix (CP) length and frame timing. The PSS and SSS may provide the cell identity. The PBCH carries some basic system information, such as downlink system bandwidth, timing information within radio frame, SS burst set periodicity, system frame number, etc.

FIG. 7 is a diagram showing an example of a radio frame sequence 700 with PRS positioning occasions. A “PRS instance” or “PRS occasion” is one instance of a periodically repeated time window (e.g., a group of one or more consecutive slots) where PRS are expected to be transmitted. A PRS occasion may also be referred to as a “PRS positioning occasion,” a “PRS positioning instance, a “positioning occasion,” “a positioning instance,” or simply an “occasion” or “instance.” Subframe sequence 700 may be applicable to broadcast of PRS signals (DL-PRS signals) from base stations 120 in positioning system 100. The radio frame sequence 700 may be used in 5G NR (e.g., in 5G NR positioning system 200) and/or in LTE. Similar to FIG. 6, time is represented horizontally (e.g., on an X axis) in FIG. 7, with time increasing from left to right. Frequency is represented vertically (e.g., on a Y axis) with frequency increasing (or decreasing) from bottom to top.

FIG. 7 shows how PRS positioning occasions 710-1, 710-2, and 710-3 (collectively and generically referred to herein as positioning occasions 710) are determined by a System Frame Number (SFN), a cell-specific subframe offset (APRS) 715, a length or span of L_{PRS} subframes, and the PRS Periodicity (T_{PRS}) 720. The cell-specific PRS subframe configuration may be defined by a “PRS Configuration Index,” I_{PRS}, included in assistance data (e.g., TDOA assistance data), which may be defined by governing 3GPP standards. The cell-specific subframe offset (APRS) 715 may be defined in terms of the number of subframes transmitted starting from System Frame Number (SFN) 0 to the start of the first (subsequent) PRS positioning occasion.

A PRS may be transmitted by wireless nodes (e.g., base stations 120) after appropriate configuration (e.g., by an Operations and Maintenance (O&M) server). A PRS may be transmitted in special positioning subframes or slots that are grouped into positioning occasions 710. For example, a PRS positioning occasion 710-1 can comprise a number NPRS of consecutive positioning subframes where the number NPRS may be between 1 and 160 (e.g., may include the values 1, 2, 4 and 6 as well as other values). PRS occasions 710 may be grouped into one or more PRS occasion groups. As noted, PRS positioning occasions 710 may occur periodically at intervals, denoted by a number T_{PRS}, of millisecond (or subframe) intervals where T_{PRS} may equal 5, 10, 20, 40, 80, 160, 320, 640, or 1280 (or any other appropriate value). In some embodiments, T_{PRS} may be measured in terms of the number of subframes between the start of consecutive positioning occasions.

In some embodiments, when a UE 105 receives a PRS configuration index I_{PRS} in the assistance data for a particular cell (e.g., base station), the UE 105 may determine the PRS periodicity T_{PRS} 720 and cell-specific subframe offset (APRS) 715 using stored indexed data. The UE 105 may then determine the radio frame, subframe, and slot when a PRS is scheduled in the cell. The assistance data may be determined by, for example, a location server (e.g., location server 160 in FIG. 1 and/or LMF 220 in FIG. 2), and includes assistance data for a reference cell, and a number of neighbor cells supported by various wireless nodes.

Typically, PRS occasions from all cells in a network that use the same frequency are aligned in time and may have a fixed known time offset (e.g., cell-specific subframe offset (APRS) 715) relative to other cells in the network that use a different frequency. In SFN-synchronous networks all wireless nodes (e.g., base stations 120) may be aligned on both frame boundary and system frame number. Therefore, in SFN-synchronous networks all cells supported by the various wireless nodes may use the same PRS configuration index for any particular frequency of PRS transmission. On the other hand, in SFN-asynchronous networks, the various wireless nodes may be aligned on a frame boundary, but not system frame number. Thus, in SFN-asynchronous networks the PRS configuration index for each cell may be configured separately by the network so that PRS occasions align in time. A UE 105 may determine the timing of the PRS occasions 710 of the reference and neighbor cells for TDOA positioning, if the UE 105 can obtain the cell timing (e.g., SFN or Frame Number) of at least one of the cells, e.g., the reference cell or a serving cell. The timing of the other cells may then be derived by the UE 105 based, for example, on the assumption that PRS occasions from different cells overlap.

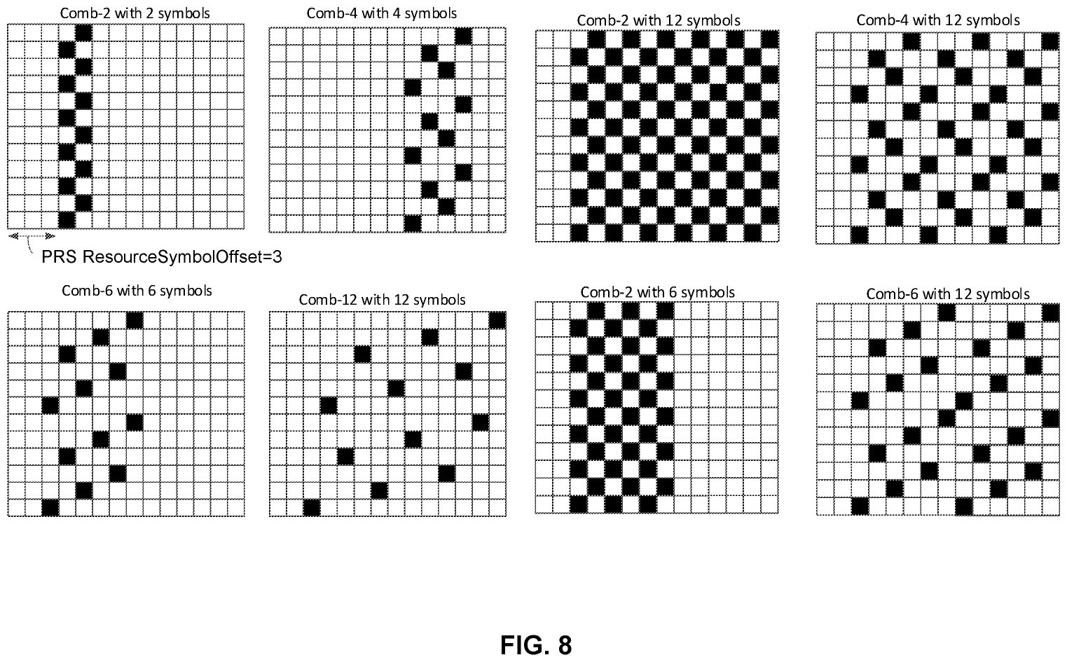

With reference to the frame structure in FIG. 4, a collection of REs that are used for transmission of PRS is referred to as a “PRS resource.” The collection of resource elements can span multiple RBs in the frequency domain and one or more consecutive symbols within a slot in the time domain, inside which pseudo-random Quadrature Phase Shift Keying (QPSK) sequences are transmitted from an antenna port of a TRP. In a given OFDM symbol in the time domain, a PRS resource occupies consecutive RBs in the frequency domain. The transmission of a PRS resource within a given RB has a particular combination, or “comb,” size. (Comb size also may be referred to as the “comb density.”) A comb size “N” represents the subcarrier spacing (or frequency/tone spacing) within each symbol of a PRS resource configuration, where the configuration uses every Nth subcarrier of certain symbols of an RB. For example, for comb-4, for each of the four symbols of the PRS resource configuration, REs corresponding to every fourth subcarrier (e.g., subcarriers 0, 4, 8) are used to transmit PRS of the PRS resource. Comb sizes of comb-2, comb-4, comb-6, and comb-12, for example, may be used in PRS. Examples of different comb sizes using with different numbers of symbols are provided in FIG. 8.

A “PRS resource set” comprises a group of PRS resources used for the transmission of PRS signals, where each PRS resource has a PRS resource ID. In addition, the PRS resources in a PRS resource set are associated with the same TRP. A PRS resource set is identified by a PRS resource set ID and is associated with a particular TRP (identified by a cell ID). A “PRS resource repetition” is a repetition of a PRS resource during a PRS occasion/instance. The number of repetitions of a PRS resource may be defined by a “repetition factor” for the PRS resource. In addition, the PRS resources in a PRS resource set may have the same periodicity, a common muting pattern configuration, and the same repetition factor across slots. The periodicity may have a length selected from 2^{m}·{4, 5, 8, 10, 16, 20, 32, 40, 64, 80, 160, 320, 640, 1280, 2560, 5120, 10240} slots, with μ=0, 1, 2, 3. The repetition factor may have a length selected from {1, 2, 4, 6, 8, 16, 32} slots.

A PRS resource ID in a PRS resource set may be associated with a single beam (and/or beam ID) transmitted from a single TRP (where a TRP may transmit one or more beams). That is, each PRS resource of a PRS resource set may be transmitted on a different beam, and as such, a PRS resource (or simply “resource”) can also be referred to as a “beam.” Note that this does not have any implications on whether the TRPs and the beams on which PRS are transmitted are known to the UE.

In the 5G NR positioning system 200 illustrated in FIG. 2, a TRP (e.g., 210, 214, 216) may transmit frames, or other physical layer signaling sequences, supporting PRS signals (i.e. a DL-PRS) according to frame configurations as previously described, which may be measured and used for position determination of the UE 105. As noted, other types of wireless network nodes, including other UEs, may also be configured to transmit PRS signals configured in a manner similar to (or the same as) that described above. Because transmission of a PRS by a wireless network node may be directed to all UEs within radio range, the wireless network node may be considered to transmit (or broadcast) a PRS.

In some embodiments, collections of REs may be allocated to a radar reference signal (RS) for use with radar systems as described above. As used herein, a “RF reference signal” or a “radar reference signal” may refer to a type of PRS, or more generally, a reference signal that allows or facilitates measurements, and ultimately detecting, ranging, and/or positioning a target object (e.g., 310, 406), e.g., in conjunction with assistance data. Radar reference signals may contain, among other things, location data and/or time reference (e.g., time stamp) for measuring or calculating parameters such as R_{T}, R_{R}, Rₛᵤₘ, Tₛᵤₘ, f_{D}, etc. (discussed with respect to FIG. 4). In some implementations, network entities such as base stations and TRPs may broadcast, transmit, or otherwise send (e.g., via unicast) radar reference signals to at least one object including at least one UE.

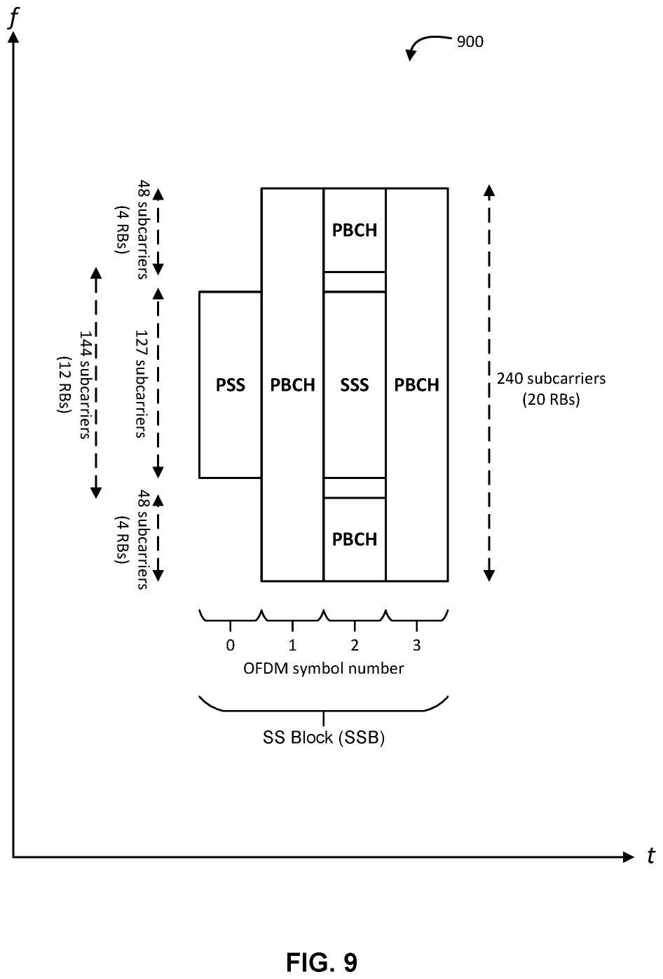

FIG. 9 is a diagram illustrating a time-frequency structure of a synchronization signal block (SSB) 900, according to one embodiment. As noted above, the SSB 900 may include a PSS, an SSS, and PBCHs. PSS, SSS, and PBCH may occupy consecutive OFDM symbols, e.g., from symbols 0 through 3, with PSS in symbol 0, SSS in symbol 2, and PBCH in symbols 1 and 3. In some embodiments, the SSB may be spread over 240 subcarriers, or 20 RBs since each RB can span 12 subcarriers. The PSS may span over 127 subcarriers occupy a single OFDM symbol. The SSS may span over 127 subcarriers and may be located in a different OFDM symbol. There may be unused subcarriers below the SSS and above the SSS. PBCH may occupy two OFDM symbols each spanning 240 subcarriers, as well as in another OFDM symbol above and below the SSS. This may result in PBCH occupying a total of 576 (240+48+48+240) subcarriers across three OFDM symbols.

In some embodiments, the SSB 900 may be periodically transmitted, e.g., broadcast from a base station (e.g., gNB 210, 214). The periodicity of the transmission may vary depending on the implementation, e.g., 5 ms, 10 ms, 20 ms, 40 ms, 80 ms or 160 ms. Longer SSB periodicities may be beneficial for energy efficiency (and thus enhance energy performance of the network), shorter periodicities may facilitate faster cell search for UEs.

### Example Multiplexing Configurations

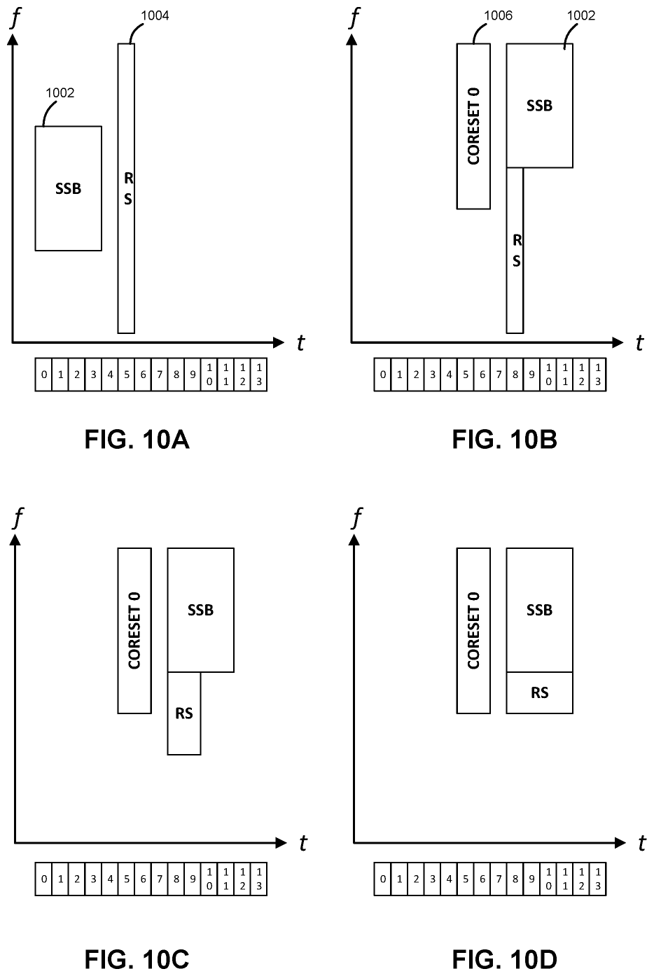

FIGS. 10A-10D are diagrams depicting various example OFDM resource grids representing time-frequency resource allocation schemes for a synchronization signal (e.g., SSB) and one or more radar reference signals (RS). In each of the examples, the SSB and the radar RS may coexist within a time-frequency allocation scheme such that their respective allocations do not cause interference with each other.

As an aside, in the following discussions, the term “allocating” may be used interchangeably with “multiplexing.” Multiplexing refers to the combination of different types of signals, e.g., synchronization signals (e.g., SSB), physical channels, and/or positioning signals (e.g., radar RS), within a set of time-frequency resources.

FIG. 10A shows one such example of an OFDM resource grid. The SSB 1002 may be allocated to OFDM symbols 0 through 3 (which is also illustrated in FIG. 9 for SSB 900) and also occupy a span of subcarriers (e.g., 240 subcarriers). The radar RS 1004 may be allocated to a different OFDM symbol, e.g., symbol 5, that does not overlap with any of the symbols for the SSB. In some embodiments, the radar RS may occupy more than one OFDM symbol, as will be illustrated in, e.g., FIGS. 10B-10D. The radar RS may occupy any frequency band needed to accommodate the information in the radar RS, including a wide frequency band as shown in FIG. 10A which spans multiple REs or RBs. Examples of frequency ranges occupied by the radar RS may include 100 MHz (e.g., in frequency range 1 (FR1)) or 400 MHz (e.g., in frequency ranges 2 and 3 (FR2 and FR3)).

The radar RS may be allocated to overlapping subcarriers (frequencies), and occupy at least a portion of the frequencies occupied by the SSB. In some cases, the frequencies for the radar RS may be a subset of, and occupy only a portion of, the frequencies for the SSB. In some cases, the frequencies for the SSB may be a subset of the frequencies for the radar RS. FIG. 10A is an example of overlapping frequencies.

The radar RS may be allocated to overlapping OFDM symbols, and occupy at least a portion of the OFDM symbols occupied by the SSB. In some cases, the OFDM symbols for the radar RS may be a subset of, and occupy only a portion of, the OFDM symbols for the SSB. In some cases, the OFDM symbols for the SSB may be a subset of the OFDM symbols for the radar RS.

FIG. 10B shows another example of an OFDM resource grid. The SSB need not necessarily be allocated to the first three OFDM symbols, and instead may be allocated to a different set of consecutive OFDM symbols, e.g., 8 through 11 as shown in FIG. 10B. In the case of FIG. 10B, the radar RS may be allocated to OFDM symbol 8; the OFDM symbols occupied by the radar RS may be a subset the OFDM symbols occupied by the SSB. This radar RS may occupy a band of frequency that is sufficient to accommodate the information. However, the frequency bands may not overlap, such that the REs or RBs occupied by the SSB and those occupied by the radar RS do not overlap, preventing any interference.

In addition, in some embodiments, resources may be allocated for Control Resource Set (CORESET) for time and/or frequency multiplexing with the SSB 1002 and/or radar RS 1004. CORESET is a set of physical resources (represented by an area on the resource grid) and a set of parameters that is used to carry physical downlink control channel (PDCCH). That is, CORESET may contain control signals. CORESET 0 is a variant of CORESET which is configured to transmit PDCCH for System Information Block 1 (SIB1) scheduling. SIB1 may include information relating to access to the cell by a UE (e.g., random access parameters), availability and scheduling of other System Information Blocks (SIBs) (periodicity, System Information (SI) window size, etc.), and/or radio resource configuration information. SIB1 may be periodically broadcast on Downlink Shared Channel (DL-SCH) or unicast on DL-SCH. Time and frequency resources may be allocated to CORESET 0 1006 with reference to (relative to) the SSB 1002.

FIG. 10C shows another example of an OFDM resource grid. The SSB may occupy OFDM symbols 8 through 11, similar to FIG. 10B. The radar RS may occupy the same number of total REs or RBs as in the configuration shown in FIG. 10B. However, the allocation of OFDM symbols and frequency band for the radar RS may be different. The radar RS in FIG. 10C may occupy twice the OFDM symbols (e.g., 8 and 9) and half the frequency band as those of FIG. 10B.

FIG. 10D shows another example of an OFDM resource grid. The SSB may occupy OFDM symbols 8 through 11, similar to FIGS. 10B and 10C. The radar RS may occupy the same OFDM symbols 8 through 11, and occupy the same quantity of REs or RBs as in the configuration shown in FIGS. 10B and 10C. However, the allocation of frequency band for the radar RS may be different and non-overlapping. The radar RS in FIG. 10C may occupy four times the OFDM symbols (e.g., 8 and 9) and a quarter the frequency band as those of FIG. 10B, or twice and half as those of FIG. 10C.

As can be seen above, as long as there are available REs in the OFDM resource grid (more specifically, time and frequency resources) that are not occupied by the SSB and other data, the radar RS may be allocated or multiplexed in any configuration that fits available time-frequency resources. In some implementations, OFDM symbols and subcarriers for the radar RS and the SSB may be proximate to one another (as in FIG. 10A), or even abut one another (as in FIGS. 10B-10D). Proximity may be defined by being within a certain extent in the frequency and/or time domain. That is, allocated resources for the radar RS may be a prescribed subcarrier distance from allocated resources for the SSB (e.g., within a determined number of REs or RBs, or within a determined distance in the frequency domain or from the SSB) and/or within a prescribed number of time slots (e.g., 2 symbols away in the time domain at most). The foregoing may advantageously increase the spectrum efficiency of the OFDM system, allowing more efficient joint delivery of radar RS along with communication data.

In some embodiments, although not illustrated in FIGS. 10A-10D, the radar RS, need not be a single consecutive block. If resource allocation for a given radar RS exceeds a number or an area of consecutive REs, for example, the radar RS may be divided into two or more blocks so as to accommodate then-current availability. In some implementations, the OFDM system may delay multiplexing or allocation of such a radar RS for another broadcast of the SSB. As noted above, the periodicity of the transmission of an SSB may vary, and depending on the implementation, the next broadcast of the SSB may be proximate enough (e.g., 5 ms later) to prevent significant drawback (e.g., delay or inaccuracy in radar positioning) from the delay in transmitting the radar RS.

Additionally, as shown in particular with FIGS. 10B-10D, it is noted that the radar RS of the same size may be multiplexed flexibly with the SSB while keeping the same allocation of resources; i.e., the “area” allocated for the radar RS is the same among FIGS. 10B-10D. On a related note, so-called numerology for 3GPP systems (e.g., 4G or 5G communications) is defined at least in part by subcarrier spacing and symbol length. Moreover, given the nature of OFDM, slot length of a radio frame (see, e.g., FIG. 7) becomes shorter as subcarrier spacing nature of OFDM becomes wider. For example, given a numerology of p=1 which corresponds to a subcarrier spacing of 30 kHz (according to 2×15 kHz), the slot length may be 0.5 ms. However, given p=2 which corresponds to a subcarrier spacing of 60 kHz, the slot length may be 0.25 ms. Hence, FIGS. 10B-10D reflect this inversely proportional relationship between subcarrier spacing and slot length. For 5G NR systems, depending on type of channel, p may be selected from 0, 1, 2, 3 and/or 4. In some embodiments, a respective numerology value (p) may be given to the radar RS and to the SSB, and may be different or the same depending on the scenario.

Quasi colocation (QCL) may refer to cases in which transmitting signals from two different antenna ports, which may normally experience different radio conditions, experience radio channels having common properties; e.g., doppler spread for both is 0.01 nanosecond. Other examples of radio channel properties include large-scale properties such as doppler shift, average delay, delay spread, average gain, and spatial receiver parameters.

The radar RS may be quasi colocated or not quasi coloated with the SSB. In some embodiments, If the measurement on one radar RS is for the purpose of measuring the direct path time of arrival (TOA), this specific radar RS may be quasi colocated with the SSB. In other embodiments, if the measurement on one radar RS is for the purpose of estimating the parameter related to the reflection path, this specific radar RS may not be expected to be quasi colocated with the SSB. If the radar RS and SSB are frequency multiplexed, a sensing receiver (e.g., at a UE) may need to operate with at least two receivers with different receiver beams.

In some embodiments, a UE configured to operate a sensing receiver may request a measurement gap configuration. A UE may need measurement gaps to perform measurements if it cannot measure the target carrier frequency while simultaneously transmitting or receiving on the serving cell. The UE may request a measurement gap so that the UE may measure the radar RS outside the active downlink bandwidth part (BWP). BWP may refer to a set of contiguous RBs configured inside a channel bandwidth. The UE may request a measurement gap also if the numerology of the radar RS is different from that of the active downlink BWP. The measurement gap for the SSB and radar RS may be jointly configured when multiplexing the radar RS and the SSB.

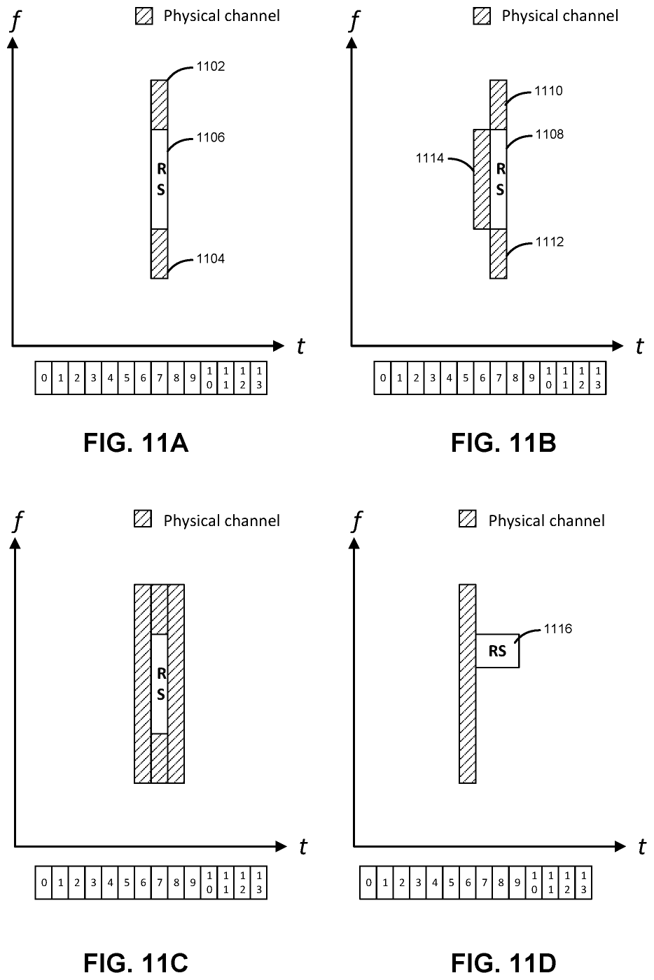

FIGS. 11A-111D are diagrams depicting various example OFDM resource grids representing time-frequency resource allocation schemes for one or more physical channels and one or more radar RS. In various embodiments, the physical channel may correspond to sets of time-frequency resources used for transmission of, e.g., transport channel data, control information, and/or indicator information. Such a physical channel may include, e.g., physical downlink shared channel (PDSCH). These physical channels may carry corresponding types of information. In each of the examples of FIGS. 11A-11D, physical channels and radar RS may coexist within a time-frequency allocation scheme such that their respective allocations do not cause interference with each other.

FIG. 11A shows one such example of an OFDM resource grid. The radar RS may be allocated to one OFDM symbol, e.g., symbol 7. It will be appreciated that the radar RS may occupy more than one OFDM symbols, as will be illustrated in, e.g., FIG. 11D. The radar RS may occupy a frequency band needed to accommodate the information (e.g., assistance data) in the radar RS, and may span a prescribed amount of REs or RBs. Examples of frequency ranges occupied by the radar RS may include 100 MHz or 400 MHz. The radar RS may occupy time-frequency resources that are available in the resource grid. In the example of FIG. 11A, the physical channel is occupying some higher frequency band(s) 1102 and lower frequency band(s) 1104, leaving frequency band(s) 1106 for the radar RS.

FIG. 11B shows another example of an OFDM resource grid. Similar to FIG. 11A, the radar RS may be allocated to one OFDM symbol and a range of frequencies 1108 not occupied by physical channels 1110, 1112 and 1114. Hence, the radar RS may be multiplexed in the same time or frequency as physical channels, but not both time and frequency. FIG. 11C further illustrates another example of the non-overlapping allocation of time-frequency resources (e.g., REs or RBs) for the radar RS and physical channels.

FIG. 11D shows another example of an OFDM resource grid. The radar RS may occupy a narrower frequency range 1116. To accommodate for the information corresponding to the radar RS, the radar RS may occupy more than one OFDM symbol, e.g., 7 through 9. Assuming that the information is of the same size as that of FIGS. 11A-11C, the “area” allocated for the radar RS may be the same. In some embodiments, a respective numerology value (p) may be given to the radar RS and to a physical channel, and may be different or the same depending on the scenario.

The radar RS may be allocated to overlapping OFDM symbols and/or subcarriers, and occupy at least a portion of the OFDM symbols and/or frequencies occupied by a particular physical channel. In some cases, the symbols and/or frequencies for the radar RS may be a subset of, and occupy only a portion of, the frequencies for a physical channel, or vice versa. In some implementations, OFDM symbols and subcarriers for the radar RS and a physical channel may be proximate to one another. FIGS. 11A-11D illustrate examples of abutting of resources for the radar RS and one or more physical channels.

### Techniques for Multiplexing

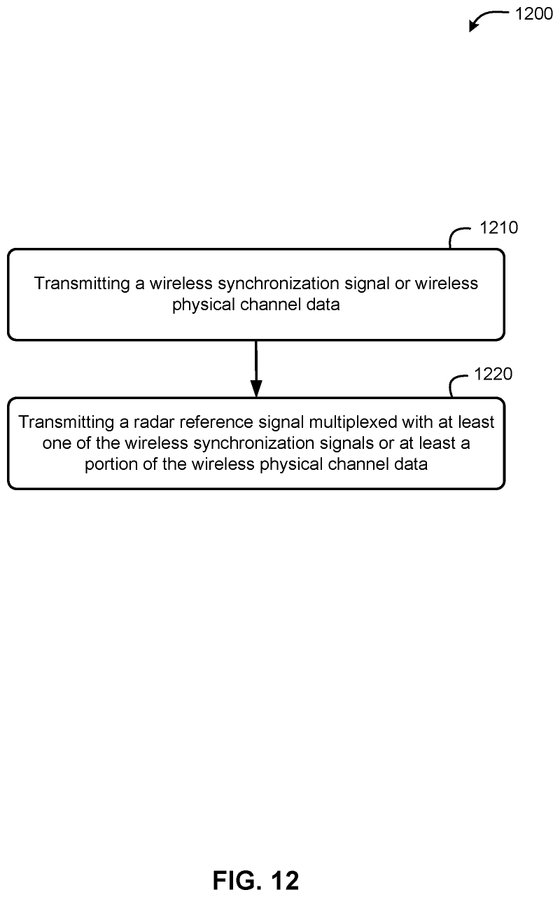

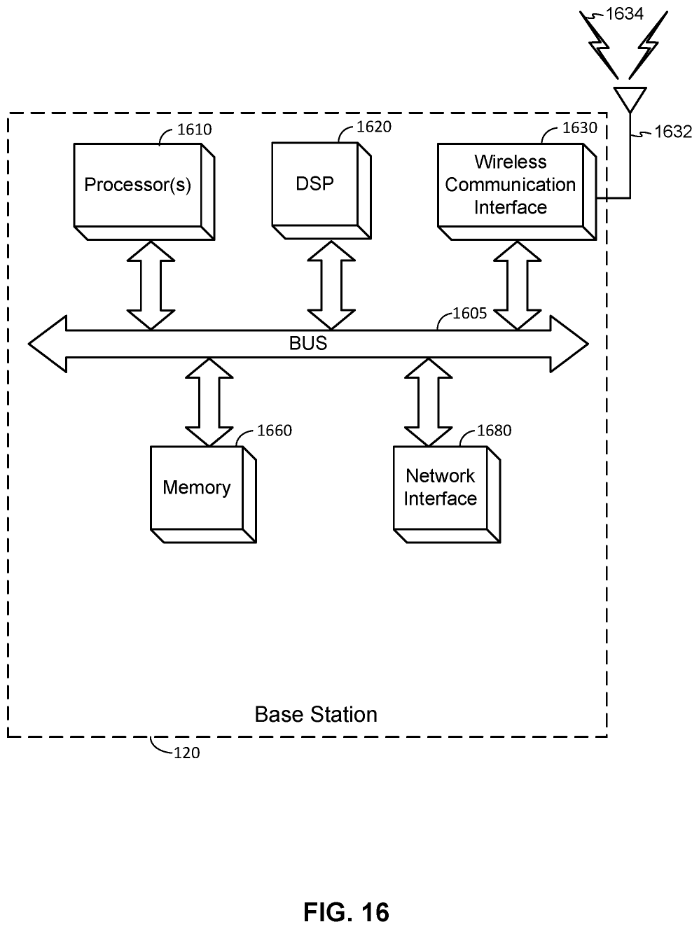

FIG. 12 is a flow diagram of a method 1200 for multiplexing radar signals with communications signals, according to some embodiments. Means for performing the functionality illustrated in one or more of the blocks shown in FIG. 12 may be performed by hardware and/or software components of a base station or TRP (or, in certain implementations, by a UE). Example components of a base station are illustrated in FIG. 16, which is described in more detail below.

At step 1210, the functionality of method 1200 may include transmitting a wireless synchronization signal or wireless physical channel data. In some embodiments, the wireless synchronization signal may include at least one SSB, e.g., SSB 900, 1002. SSBs may be cell-wise broadcast signals. SSBs may be periodically transmitted according to a periodicity (e.g., 5 ms, 10 ms, 160 ms). In some embodiments, CORESET (e.g., CORESET 0) may be transmitted along with an SSB. In some implementations, SSBs may be encapsulated within beacon frames.

In some embodiments, the wireless physical channel data comprises data carried by physical channels (e.g., PDSCH). Information carried by a physical channel may be unicast to, e.g., a UE in a unicast signal. In some embodiments, PDSCH, for example, may be transmitted to the UE only during certain times, e.g., when requested, buffered, or scheduled. In other embodiments, PDSCH may be transmitted to the UE periodically.

At step 1220, the functionality of method 1200 may include transmitting a radar reference signal multiplexed with at least one of the wireless synchronization signals or at least a portion of the wireless physical channel data. In some embodiments, the base station may identify a broadcast of one or more wireless synchronization signals (e.g., SSB), and multiplex at least one radar RS by allocating time-frequency resources in a non-overlapping manner with the wireless synchronization signals, e.g., as illustrated in FIGS. 10A-10D. In some embodiments, the base station may identify one or more physical channels (e.g., PDSCH), and multiplex at least one RS by allocating time-frequency resources in a non-overlapping manner with physical channel data, e.g., as illustrated in FIGS. 11A-11D. As such, transmission by a base station according to an OFDM scheme may advantageously possess greater spectrum efficiency than, e.g., transmitting in a separate radio frame.

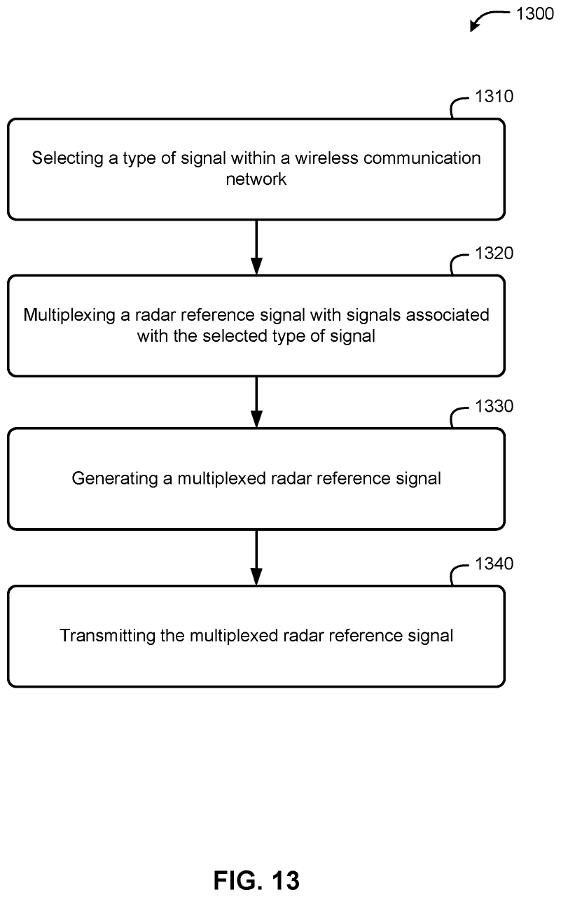

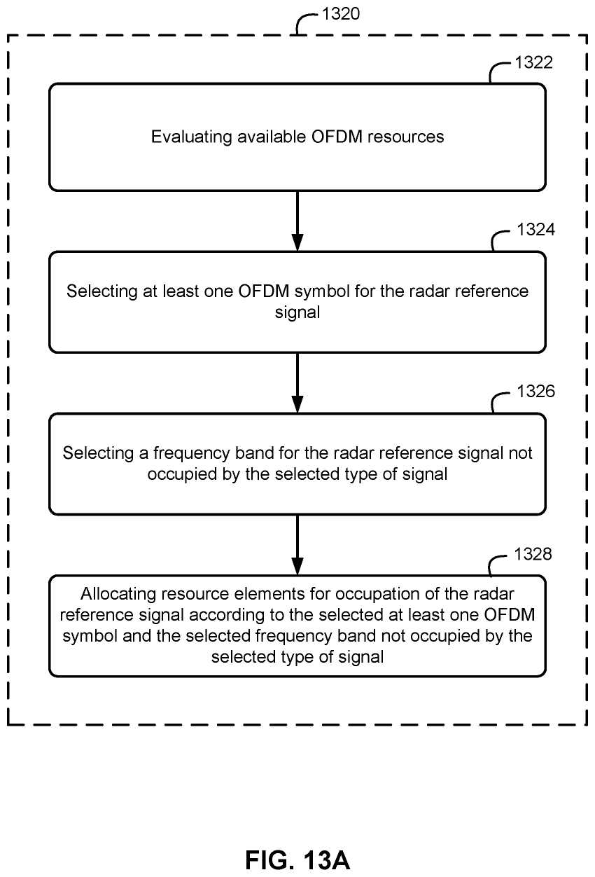

FIG. 13 is a flow diagram of a method 1300 for multiplexing radar signals with communications signals, according to some embodiments. Means for performing the functionality illustrated in one or more of the blocks shown in FIG. 13 may be performed by hardware and/or software components of a base station or TRP (or, in certain implementations, by a UE). Example components of a base station are illustrated in FIG. 16, which is described in more detail below.

At step 1310, the functionality of method 1300 may include selecting a type of signal within a wireless communication network. In some embodiments, the selection may include a selection from different types of signals, including wireless synchronization signals (e.g., SSBs) or wireless physical channel data (e.g., carried by PDSCH). In some embodiments, the selection of the type of signal may result in configuring to be transmitted the selected type of signal, i.e., the wireless synchronization signal or the wireless physical channel data (e.g., broadcast or unicast, respectively).

At step 1320, the functionality of method 1300 may include multiplexing a radar reference signal with signals associated with the selected type of signal. In some embodiments, multiplexing the radar RS may include allocating time-frequency resources in a non-overlapping manner with the signals associated with the selected type of signal. For example, OFDM symbols (time domain) and subcarriers (frequency domain) that are not occupied by the signals may be allocated to the radar RS, which may be performed in one of myriad ways, as shown in, e.g., FIGS. 10A-11D.

In some embodiments, additional sub-steps may be involved in the multiplexing of step 1320. Turning momentarily to FIG. 13A, a flow diagram is illustrated for the multiplexing step, according to some embodiments. Means for performing the functionality illustrated in one or more of the blocks shown in FIG. 13A may be performed by hardware and/or software components of a base station or TRP. Example components of a base station are illustrated in FIG. 16, which is described in more detail below.

At step 1322, the functionality of step 1320 may include evaluating available OFDM resources. In some embodiments, the evaluation may include identifying time-frequency resources, e.g., REs and/or RBs. Such time-frequency resources may be represented as a resource grid as illustrated in, e.g., FIGS. 6, 8 and 10A-11D. Although the foregoing illustrations do not include all occupied resources, in myriad scenarios, all resources may be occupied, some resources may be occupied, or none of the resources may be occupied. In situations where some resources are occupied, there may not be sufficient space (“area”) or “geometry” so as to allow allocation of resources for radar RS. For instance, if the radar RS requires a certain number n of REs and the resource grid for a given radio frame does not have a contiguous set of REs that exceed the number of REs required, the evaluation at step 1322 may indicate that the radar RS should not be multiplexed with the existing signals or data (SSB, CORESET 0, PDSCH, etc.). In some implementations, if there are non-contiguous sets of REs (e.g., two or more “areas” on the resource grid) totaling or exceeding the required n REs available, the radar RS may be allocated to the available sets of REs in corresponding portions.

At step 1324, the functionality of step 1320 may include selecting at least one OFDM symbol for the radar reference signal. In some embodiments, the selection of an OFDM symbol may be based on the available resources identified in step 1322. For example, OFDM symbol 5 may not be occupied, partially or entirely, by an SSB or a physical channel. Hence, symbol 5 may be selected.

At step 1326, the functionality of step 1320 may include selecting a frequency band for the for the radar reference signal not occupied by the selected type of signal. In some embodiments, this selection may correspond to the available resources as identified in step 1322. As but one example, a particular set of REs or RBs at OFDM symbol 5 may not be occupied by the SSB nor the physical channel. Hence, this frequency range may be selected.

At step 1328, the functionality of step 1320 may include allocating resource elements for occupation of the radar reference signal according to the selected at least one OFDM symbol and the selected frequency band not occupied by the selected type of signal. In some embodiments, the allocation includes to identifying REs and/or RBs that correspond to the time and frequency resources selected in steps 1324 and 1326. In the above example, REs corresponding to the “area” defined by OFDM symbol 5 and the 360-kHz frequency range may be allocated to the radar RS.

Returning to FIG. 13, at step 1330, the functionality of method 1300 may include generating a multiplexed radar reference signal. In some embodiments, the multiplexed radar RS may occupy time-frequency resources (e.g., REs or RBs) that do not overlap with other signals such as SSB or physical channels. The lack of overlap may be determined partly by steps 1320-1328. Thus, the multiplexed radar RS may be capable of being transmitted with the other signals to be (or being) transmitted with enhanced spectrum efficiency, without having to be, e.g., encapsulated in a separate radio frame.

At step 1340, the functionality of method 1300 may include transmitting the multiplexed radar reference signal. In some embodiments, the multiplexed radar RS may be broadcast, if multiplexed with synchronization signals (e.g., SSB) in step 1320. In some embodiments, the multiplexed radar RS may be unicast or directly transmitted to a UE, if multiplexed with physical channels (e.g., PDSCH) in step 1320.

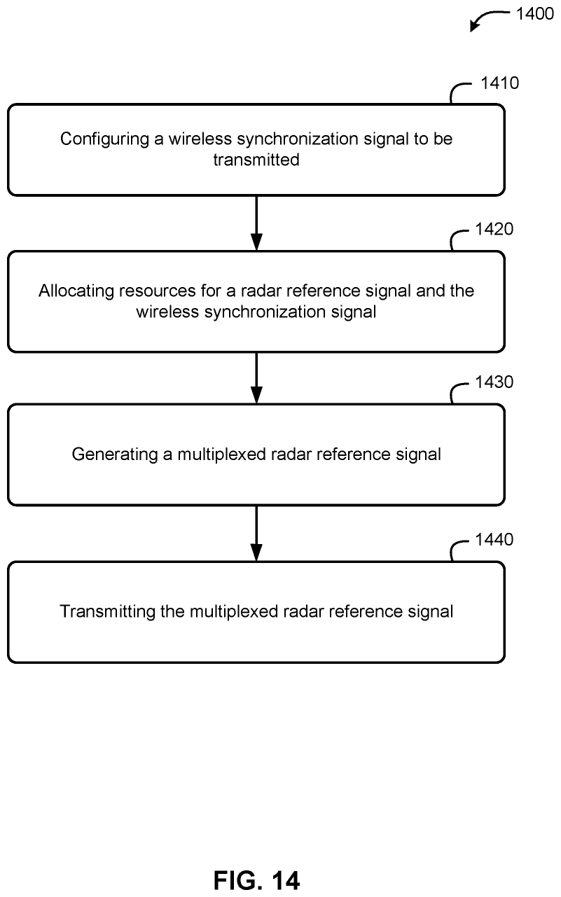

FIG. 14 is a flow diagram of a method 1400 for multiplexing radar signals with synchronization signals, according to some embodiments. Means for performing the functionality illustrated in one or more of the blocks shown in FIG. 14 may be performed by hardware and/or software components of a base station or TRP (or, in certain implementations, by a UE). Example components of a base station are illustrated in FIG. 16, which is described in more detail below.

At step 1410, the functionality of method 1400 may include configuring a wireless synchronization signal to be transmitted. In some embodiments, the wireless synchronization signal may include at least an SSB. In some embodiments, CORESET (e.g., CORESET 0) may accompany the SSB. Configuration of the synchronization signal may include initiating, scheduling, or queueing for broadcast.

At step 1420, the functionality of method 1400 may include allocating resources for a radar reference signal and the wireless synchronization signal. In some embodiments, the allocation of resources may include first determining REs or RBs corresponding to time-frequency resources on the resource grid which are unused by the synchronization signal (e.g., SSB), and then allocating the unused resources to the radar RS. Examples of resource allocation for a radar RS and a synchronization signal in time and frequency domains are illustrated in, e.g., FIGS. 10A-10D.

At step 1430, the functionality of method 1400 may include generating a multiplexed radar reference signal. In some embodiments, a multiplexed signal containing at least the synchronization signal (e.g., SSB) and a radar RS may be generated according to the time and frequency resource allocation in step 1420.

At step 1440, the functionality of method 1400 may include transmitting the multiplexed radar reference signal. In some embodiments, the transmission may be a broadcast. Each broadcast may contain the radar RS, and may have a prescribed periodicity and broadcast every 5 ms, 10 ms, 20 ms, etc. In some implementations, the multiplexed radar RS may be cell-wise broadcast signal, rather than a device-specific signal that is unicast to, e.g., a specific UE. Depending on the scenario, the broadcast multiplexed radar RS may interact with (e.g., reflect off) an object whose location is sought to be determined, and when correlated with a reflected version of the radar RS, serve as a basis for one or more radar measurements using monostatic, bistatic, or multi-static radar systems (e.g., according to FIGS. 3-5).

The target object (e.g., object 310 or target 406) may not necessarily include a wireless-enabled device such as a UE. Radar-based positioning of such objects may be performed using the aforementioned radar systems. If the target object includes a UE, the UE may be configured to detect the broadcast signal and the SSB therein. In some embodiments, the SSB may be detected by expecting the SSB signal according to periodicity (e.g., 20 ms) acquired from, e.g., assistance data, and performing a raster search where the UE may search for the SSB across frequencies in increments. The radar RS may then be located based on information contained in the SSB signal. The UE may be configured to transmit a return signal to a receiver (e.g., 404, 504) based on receipt of the radar RS, and enable positioning thereof.

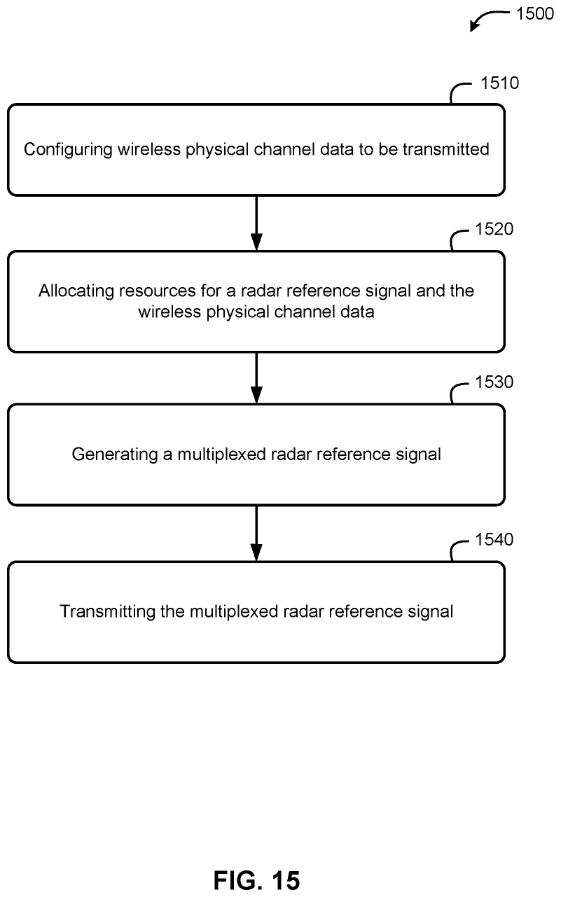

FIG. 15 is a flow diagram of a method 1500 for multiplexing radar signals with a physical channel, according to some embodiments. Means for performing the functionality illustrated in one or more of the blocks shown in FIG. 15 may be performed by hardware and/or software components of a base station or TRP (or, in certain implementations, by a UE). Example components of a base station are illustrated in FIG. 16, which is described in more detail below.

At step 1510, the functionality of method 1500 may include configuring wireless physical channel data to be transmitted. In some embodiments, the physical channel data may include at least data to be carried in a physical channel, such as PDSCH. In some implementations, the configuration may be initiated by a base station or TRP. In some implementations, the configuration may be in response to a request by a UE, another base station or TRP, a server, etc. Configuration of the physical channel data may include initiating, scheduling, or queueing for unicast transmission.

At step 1520, the functionality of method 1500 may include allocating resources for a radar reference signal and the wireless physical channel data. In some embodiments, the multiplexing may include first determining REs and/or RBs corresponding to time-frequency resources on the resource grid which are unused by any physical channels (e.g., PDSCH), and then allocating the unused resources to the radar RS. Examples of resource allocations for a radar RS and physical channels in time and frequency domains are illustrated in, e.g., FIGS. 11A-11D.

At step 1530, the functionality of method 1500 may include generating a multiplexed radar reference signal. In some embodiments, a multiplexed signal containing at least the physical channel data and a radar RS may be generated according to the time and frequency resource allocation in step 1520.

At step 1540, the functionality of method 1500 may include transmitting the multiplexed radar reference signal. In some embodiments, the transmission may be a unicast that is performed at a specified time or time window.

Depending on the scenario, the radar RS may be used for multi-TRP implementations, if the radar RS is multiplexed with a physical channel. For example, the multiplexed radar RS may be transmitted or relayed to one or more other base stations or TRPs. One of the other base stations or TRPs may then transmit or broadcast the multiplexed radar RS for positioning, e.g., of an object or a UE. As another example, any given pair of TRPs or base stations (a bistatic system) of a multi-static radar systems may transmit and receive the multiplexed radar RS according to the principles described above.

Depending on the scenario, the unicast multiplexed radar RS may interact with (e.g., reflect off) an object whose location is sought to be determined (e.g., a UE), and when correlated with a reflected version of the radar RS, serve as a basis for one or more radar measurements.

In some embodiments, the transmission may include signaling the time and/or frequency location of the radar RS for rate matching. Rate matching may refer to an operation aided by the signaling (which may occur via, e.g., Radio Resource Control (RRC) protocol, Downlink Control Information (DCI), or Medium Access Control (MAC) Control Element (MAC-CE)), such that where a radar RS is to be transmitted, no PDSCH will be transmitted. More specifically, some REs may be punctured by radar RS to avoid transmission of PDSCH on those REs, where “puncture” as used herein may generally refer to use of a resource scheduled for other traffic. Consequently, PSDCH will not be transmitted on those REs, and instead the radar RS may be allowed to use those REs. The UE may then be configured to transmit a return signal based on receipt of the radar RS, and enable positioning thereof (e.g., according to FIGS. 3-5).

### Apparatus

FIG. 16 illustrates an embodiment of a base station 120, which can be utilized as described herein above (e.g., in association with FIGS. 12-15). For example, the base station 120 can perform one or more of the functions of the methodology shown in FIGS. 12-15. It should be noted that FIG. 16 is meant only to provide a generalized illustration of various components, any or all of which may be utilized as appropriate. In some embodiments, the base station 120 may correspond to a gNB, an ng-eNB, and/or (more generally) a TRP.

The base station 120 is shown comprising hardware elements that can be electrically coupled via a bus 1605 (or may otherwise be in communication, as appropriate). The hardware elements may include a processor(s) 1610 which can include without limitation one or more general-purpose processors, one or more special-purpose processors (such as DSP chips, graphics acceleration processors, ASICs, and/or the like), and/or other processing structure or means. As shown in FIG. 16, some embodiments may have a separate DSP 1620, depending on desired functionality. Location determination and/or other determinations based on wireless communication may be provided in the processor(s) 1610 and/or wireless communication interface 1630 (discussed below), according to some embodiments. The base station 120 also can include one or more input devices, which can include without limitation a keyboard, display, mouse, microphone, button(s), dial(s), switch(es), and/or the like; and one or more output devices, which can include without limitation a display, light emitting diode (LED), speakers, and/or the like.

The base station 120 might also include a wireless communication interface 1630, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, cellular communication facilities, etc.), and/or the like, which may enable the base station 120 to communicate as described herein. The wireless communication interface 1630 may permit data and signaling to be communicated (e.g., transmitted and received) to UEs, other base stations/TRPs (e.g., eNBs, gNBs, and ng-eNBs), and/or other network components, computer systems, and/or any other electronic devices described herein. The communication can be carried out via one or more wireless communication antenna(s) 1632 that send and/or receive wireless signals 1634.

The base station 120 may also include a network interface 1680, which can include support of wireline communication technologies. The network interface 1680 may include a modem, network card, chipset, and/or the like. The network interface 1680 may include one or more input and/or output communication interfaces to permit data to be exchanged with a network, communication network servers, computer systems, and/or any other electronic devices described herein.

In many embodiments, the base station 120 may further comprise a memory 1660. The memory 1660 can include, without limitation, local and/or network accessible storage, a disk drive, a drive array, an optical storage device, a solid-state storage device, such as a RAM, and/or a ROM, which can be programmable, flash-updateable, and/or the like. Such storage devices may be configured to implement any appropriate data stores, including without limitation, various file systems, database structures, and/or the like.

The memory 1660 of the base station 120 also may comprise software elements (not shown in FIG. 16), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 1660 that are executable by the base station 120 (and/or processor(s) 1610 or DSP 1620 within base station 120). In some embodiments, then, such code and/or instructions can be used to configure and/or adapt a general-purpose computer (or other device) to perform one or more operations in accordance with the described methods.

FIG. 17 is a block diagram of an embodiment of a UE 105, which can be utilized as described herein above (e.g., in association with FIGS. 12-15). For example, the UE 105 can perform, and/or be utilized in conjunction with, one or more of the functions of the methodology shown in FIGS. 12-15. It should be noted that FIG. 17 is meant only to provide a generalized illustration of various components, any or all of which may be utilized as appropriate. It can be noted that, in some instances, components illustrated by FIG. 17 can be localized to a single physical device and/or distributed among various networked devices, which may be disposed at different physical locations. Furthermore, as previously noted, the functionality of the UE discussed in the previously described embodiments may be executed by one or more of the hardware and/or software components illustrated in FIG. 17.

The UE 105 is shown comprising hardware elements that can be electrically coupled via a bus 1705 (or may otherwise be in communication, as appropriate). The hardware elements may include a processor(s) 1710 which can include without limitation one or more general-purpose processors (e.g., an application processor), one or more special-purpose processors (such as digital signal processor (DSP) chips, graphics acceleration processors, application specific integrated circuits (ASICs), and/or the like), and/or other processing structures or means. Processor(s) 1710 may comprise one or more processing units, which may be housed in a single integrated circuit (IC) or multiple ICs. As shown in FIG. 17, some embodiments may have a separate DSP 1720, depending on desired functionality. Location determination and/or other determinations based on wireless communication may be provided in the processor(s) 1710 and/or wireless communication interface 1730 (discussed below). The UE 105 also can include one or more input devices 1770, which can include without limitation one or more keyboards, touch screens, touch pads, microphones, buttons, dials, switches, and/or the like; and one or more output devices 1715, which can include without limitation one or more displays (e.g., touch screens), light emitting diodes (LEDs), speakers, and/or the like.

The UE 105 may also include a wireless communication interface 1730, which may comprise without limitation a modem, a network card, an infrared communication device, a wireless communication device, and/or a chipset (such as a Bluetooth® device, an IEEE 802.11 device, an IEEE 802.15.4 device, a Wi-Fi device, a WiMAX device, a WAN device, and/or various cellular devices, etc.), and/or the like, which may enable the UE 105 to communicate with other devices as described in the embodiments above. The wireless communication interface 1730 may permit data and signaling to be communicated (e.g., transmitted and received) with TRPs of a network, for example, via eNBs, gNBs, ng-eNBs, access points, various base stations and/or other access node types, and/or other network components, computer systems, and/or any other electronic devices communicatively coupled with TRPs, as described herein. The communication can be carried out via one or more wireless communication antenna(s) 1732 that send and/or receive wireless signals 1734. According to some embodiments, the wireless communication antenna(s) 1732 may comprise a plurality of discrete antennas, antenna arrays, or any combination thereof. The antenna(s) 1732 may be capable of transmitting and receiving wireless signals using beams (e.g., Tx beams and Rx beams). Beam formation may be performed using digital and/or analog beam formation techniques, with respective digital and/or analog circuitry. The wireless communication interface 1730 may include such circuitry.

Depending on desired functionality, the wireless communication interface 1730 may comprise a separate receiver and transmitter, or any combination of transceivers, transmitters, and/or receivers to communicate with base stations (e.g., ng-eNBs and gNBs) and other terrestrial transceivers, such as wireless devices and access points. The UE 105 may communicate with different data networks that may comprise various network types. For example, a Wireless Wide Area Network (WWAN) may be a CDMA network, a Time Division Multiple Access (TDMA) network, a Frequency Division Multiple Access (FDMA) network, an Orthogonal Frequency Division Multiple Access (OFDMA) network, a Single-Carrier Frequency Division Multiple Access (SC-FDMA) network, a WiMAX (IEEE 802.16) network, and so on. A CDMA network may implement one or more RATs such as CDMA2000@, WCDMA, and so on. CDMA2000@includes IS-95, IS-2000 and/or IS-856 standards. A TDMA network may implement GSM, Digital Advanced Mobile Phone System (D-AMPS), or some other RAT. An OFDMA network may employ LTE, LTE Advanced, 5G NR, and so on. 5G NR, LTE, LTE Advanced, GSM, and WCDMA are described in documents from 3GPP. CDMA2000@ is described in documents from a consortium named “3rd Generation Partnership Project 2” (3GPP2). 3GPP and 3GPP2 documents are publicly available. A wireless local area network (WLAN) may also be an IEEE 802.11x network, and a wireless personal area network (WPAN) may be a Bluetooth network, an IEEE 802.15x, or some other type of network. The techniques described herein may also be used for any combination of WWAN, WLAN and/or WPAN.

The UE 105 can further include sensor(s) 1740. Sensor(s) 1740 may comprise, without limitation, one or more inertial sensors and/or other sensors (e.g., accelerometer(s), gyroscope(s), camera(s), magnetometer(s), altimeter(s), microphone(s), proximity sensor(s), light sensor(s), barometer(s), and the like), some of which may be used to obtain position-related measurements and/or other information.

Embodiments of the UE 105 may also include a Global Navigation Satellite System (GNSS) receiver 1780 capable of receiving signals 1784 from one or more GNSS satellites using an antenna 1782 (which could be the same as antenna 1732). Positioning based on GNSS signal measurement can be utilized to complement and/or incorporate the techniques described herein. The GNSS receiver 1780 can extract a position of the UE 105, using conventional techniques, from GNSS satellites 110 of a GNSS system, such as Global Positioning System (GPS), Galileo, GLONASS, Quasi-Zenith Satellite System (QZSS) over Japan, IRNSS over India, BeiDou Navigation Satellite System (BDS) over China, and/or the like. Moreover, the GNSS receiver 1780 can be used with various augmentation systems (e.g., a Satellite Based Augmentation System (SBAS)) that may be associated with or otherwise enabled for use with one or more global and/or regional navigation satellite systems, such as, e.g., Wide Area Augmentation System (WAAS), European Geostationary Navigation Overlay Service (EGNOS), Multi-functional Satellite Augmentation System (MSAS), and Geo Augmented Navigation system (GAGAN), and/or the like.

It can be noted that, although GNSS receiver 1780 is illustrated in FIG. 17 as a distinct component, embodiments are not so limited. As used herein, the term “GNSS receiver” may comprise hardware and/or software components configured to obtain GNSS measurements (measurements from GNSS satellites). In some embodiments, therefore, the GNSS receiver may comprise a measurement engine executed (as software) by one or more processors, such as processor(s) 1710, DSP 1720, and/or a processor within the wireless communication interface 1730 (e.g., in a modem). A GNSS receiver may optionally also include a positioning engine, which can use GNSS measurements from the measurement engine to determine a position of the GNSS receiver using an Extended Kalman Filter (EKF), Weighted Least Squares (WLS), a hatch filter, particle filter, or the like. The positioning engine may also be executed by one or more processors, such as processor(s) 1710 or DSP 1720.

The UE 105 may further include and/or be in communication with a memory 1760. The memory 1760 can include, without limitation, local and/or network accessible storage, a disk drive, a drive array, an optical storage device, a solid-state storage device, such as a random access memory (RAM), and/or a read-only memory (ROM), which can be programmable, flash-updateable, and/or the like. Such storage devices may be configured to implement any appropriate data stores, including without limitation, various file systems, database structures, and/or the like.

The memory 1760 of the UE 105 also can comprise software elements (not shown in FIG. 17), including an operating system, device drivers, executable libraries, and/or other code, such as one or more application programs, which may comprise computer programs provided by various embodiments, and/or may be designed to implement methods, and/or configure systems, provided by other embodiments, as described herein. Merely by way of example, one or more procedures described with respect to the method(s) discussed above may be implemented as code and/or instructions in memory 1760 that are executable by the UE 105 (and/or processor(s) 1710 or DSP 1720 within UE 105). In some embodiments, then, such code and/or instructions can be used to configure and/or adapt a general-purpose computer (or other device) to perform one or more operations in accordance with the described methods.

It will be apparent to those skilled in the art that substantial variations may be made in accordance with specific requirements. For example, customized hardware might also be used and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium” as used herein, refer to any storage medium that participates in providing data that causes a machine to operate in a specific fashion. In embodiments provided hereinabove, various machine-readable media might be involved in providing instructions/code to processors and/or other device(s) for execution. Additionally or alternatively, the machine-readable media might be used to store and/or carry such instructions/code. In many implementations, a computer-readable medium is a physical and/or tangible storage medium. Such a medium may take many forms, including but not limited to, non-volatile media and volatile media. Common forms of computer-readable media include, for example, magnetic and/or optical media, any other physical medium with patterns of holes, a RAM, a programmable ROM (PROM), erasable PROM (EPROM), a FLASH-EPROM, any other memory chip or cartridge, or any other medium from which a computer can read instructions and/or code.

The methods, systems, and devices discussed herein are examples. Various embodiments may omit, substitute, or add various procedures or components as appropriate. For instance, features described with respect to certain embodiments may be combined in various other embodiments. Different aspects and elements of the embodiments may be combined in a similar manner. The various components of the figures provided herein can be embodied in hardware and/or software. Also, technology evolves and, thus many of the elements are examples that do not limit the scope of the disclosure to those specific examples.

It has proven convenient at times, principally for reasons of common usage, to refer to such signals as bits, information, values, elements, symbols, characters, variables, terms, numbers, numerals, or the like. It should be understood, however, that all of these or similar terms are to be associated with appropriate physical quantities and are merely convenient labels. Unless specifically stated otherwise, as is apparent from the discussion above, it is appreciated that throughout this Specification discussion utilizing terms such as “processing,” “computing,” “calculating,” “determining,” “ascertaining,” “identifying,” “associating,” “measuring,” “performing,” or the like refer to actions or processes of a specific apparatus, such as a special purpose computer or a similar special purpose electronic computing device. In the context of this Specification, therefore, a special purpose computer or a similar special purpose electronic computing device is capable of manipulating or transforming signals, typically represented as physical electronic, electrical, or magnetic quantities within memories, registers, or other information storage devices, transmission devices, or display devices of the special purpose computer or similar special purpose electronic computing device.

Terms, “and” and “or” as used herein, may include a variety of meanings that also is expected to depend, at least in part, upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AA, AAB, AABBCCC, etc.

Having described several embodiments, various modifications, alternative constructions, and equivalents may be used without departing from the scope of the disclosure. For example, the above elements may merely be a component of a larger system, wherein other rules may take precedence over or otherwise modify the application of the various embodiments. Also, a number of steps may be undertaken before, during, or after the above elements are considered. Accordingly, the above description does not limit the scope of the disclosure.

In view of this description embodiments may include different combinations of features. Implementation examples are described in the following numbered clauses:

Clause 1: A method of multiplexing radar signals with communications signals, the method comprising: transmitting (a) a wireless synchronization signal or (b) wireless physical channel data, wherein the wireless synchronization signal comprises a periodically transmitted broadcast signal, and wherein the wireless physical channel data comprises a unicast signal directed to a user equipment (UE); and transmitting a radar reference signal multiplexed with the wireless synchronization signal or the wireless physical channel data, wherein the radar reference signal is configured to, when correlated with a reflected version of the radar reference signal, serve as a basis for one or more radar measurements.

Clause 2: The method of clause 1, further comprising: selecting the wireless synchronization signal, the wireless synchronization signal comprising a synchronization signal block (SSB); and multiplexing, in one or more of a time domain or a frequency domain, resources associated with the radar reference signal with resources associated with the SSB, resulting in a radar reference signal multiplexed with the SSB; wherein the transmitting of the radar reference signal comprises periodically broadcasting the radar reference signal multiplexed with the SSB from a transmission reception point (TRP).

Clause 3: The method of any of clauses 1-2 further comprising selecting the wireless physical channel data, the wireless physical channel data corresponding to at least one physical channel; and multiplexing, in one or more of a time domain or a frequency domain, resources associated with the radar reference signal with resources associated with the at least one physical channel, resulting in a radar reference signal multiplexed with the unicast signal; wherein the transmitting of the radar reference signal comprises transmitting the radar reference signal multiplexed with the unicast signal from a transmission reception point (TRP).

Clause 4: The method of any of clauses 1-3 wherein the at least one physical channel comprises a physical downlink shared channel (PDSCH).

Clause 5: The method of any of clauses 1-4 further comprising multiplexing the radar reference signal with the wireless synchronization signal or the wireless physical channel data in one or more of a time domain or a frequency domain according to an orthogonal frequency-division multiplexing (OFDM) scheme.

Clause 6: The method of any of clauses 1-5 wherein the multiplexing the radar reference signal with the wireless synchronization signal or the wireless physical channel data further comprises: allocating a first set of time-frequency resources for the radar reference signal; and allocating a second set of time-frequency resources for the wireless synchronization signal or at least a physical channel corresponding to the wireless physical channel data.

Clause 7: The method of any of clauses 1-6 wherein the first set of time-frequency resources for the radar reference signal comprises a subset of OFDM symbols occupied by the second set of time-frequency resources for the wireless synchronization signal or the at least physical channel corresponding to the wireless physical channel data.

Clause 8: The method of any of clauses 1-7 wherein the first set of time-frequency resources for the radar reference signal comprises a subset of subcarriers occupied by the second set of time-frequency resources for the wireless synchronization signal or the at least physical channel corresponding to the wireless physical channel data.

Clause 9: The method of any of clauses 1-8 wherein the first set of time-frequency resources is proximate to the second set of time-frequency resources by a prescribed extent in time or frequency.

Clause 10: The method of any of clauses 1-9 wherein the multiplexing the radar reference signal with the wireless synchronization signal or the wireless physical channel data further comprises: evaluating available time-frequency resources; selecting at least one OFDM symbol for the radar reference signal based at least on the available time-frequency resources; selecting a frequency band for the radar reference signal, the frequency band not occupied by the wireless synchronization signal or the wireless physical channel data; and allocating resource elements for occupation of the radar reference signal according to the selected at least one OFDM symbol and the selected frequency band not occupied by the wireless synchronization signal or the wireless physical channel data.

Clause 11: The method of any of clauses 1-10 further comprising multiplexing, in one or more of a time domain or a frequency domain, resources associated with the radar reference signal with resources associated with the wireless synchronization signal and resources associated with a Control Resource Set (CORESET) signal.

Clause 12: A transmission reception point (TRP) comprising: one or more wireless communications interfaces; memory; and one or more processors communicatively coupled to the memory and the one or more wireless communication interface, and configured to: transmit (a) a wireless synchronization signal or (b) wireless physical channel data, wherein the wireless synchronization signal comprises a periodically transmitted broadcast signal, and wherein the wireless physical channel data comprises a unicast signal directed to a user equipment (UE); and transmit a radar reference signal multiplexed with the wireless synchronization signal or the wireless physical channel data, wherein the radar reference signal is configured to, when correlated with a reflected version of the radar reference signal, serve as a basis for one or more radar measurements.

Clause 13: The TRP of clause 12, wherein the one or more processors are further configured to: select the wireless synchronization signal, the wireless synchronization signal comprising a synchronization signal block (SSB); and multiplex, in one or more of a time domain or a frequency domain, resources associated with the radar reference signal with resources associated with the SSB, resulting in a radar reference signal multiplexed with the SSB; wherein the transmission of the radar reference signal comprises a periodic broadcast of the radar reference signal multiplexed with the SSB from the transmission reception point (TRP).

Clause 14: The TRP of any of clauses 12-13 wherein the one or more processors are further configured to: select the wireless physical channel data, the wireless physical channel data corresponding to at least one physical channel; and multiplex, in one or more of a time domain or a frequency domain, resources associated with the radar reference signal with resources associated with the at least one physical channel, resulting in a radar reference signal multiplexed with the unicast signal; wherein the transmission of the radar reference signal comprises transmitting the radar reference signal multiplexed with the unicast signal from a transmission reception point (TRP).

Clause 15: The TRP of any of clauses 12-14 wherein the at least one physical channel comprises a physical downlink shared channel (PDSCH).

Clause 16: The TRP of any of clauses 12-15 wherein the one or more processors are further configured to multiplex the radar reference signal with the wireless synchronization signal or the wireless physical channel data in one or more of a time domain or a frequency domain according to an orthogonal frequency-division multiplexing (OFDM) scheme.

Clause 17: The TRP of any of clauses 12-16 wherein the multiplexing of the radar reference signal with the wireless synchronization signal or the wireless physical channel data further comprises: allocation of a first set of time-frequency resources for the radar reference signal; and allocation of a second set of time-frequency resources for the wireless synchronization signal or at least a physical channel corresponding to the wireless physical channel data.

Clause 18: The TRP of any of clauses 12-17 wherein the multiplexing of the radar reference signal with the wireless synchronization signal or the wireless physical channel data further comprises: evaluation of available time-frequency resources; selection of at least one OFDM symbol for the radar reference signal based at least on the available time-frequency resources; selection of a frequency band for the radar reference signal, the frequency band not occupied by the wireless synchronization signal or the wireless physical channel data; and allocation of resource elements for occupation of the radar reference signal according to the selected at least one OFDM symbol and the selected frequency band not occupied by the wireless synchronization signal or the wireless physical channel data.

Clause 19: The TRP of any of clauses 12-18 wherein the one or more processors are further configured to multiplex, in one or more of a time domain or a frequency domain, resources associated with the radar reference signal with resources associated with the wireless synchronization signal and resources associated with a Control Resource Set (CORESET) signal.

Clause 20: A non-transitory computer-readable apparatus comprising a storage medium, the storage medium comprising a plurality of instructions configured to, when executed by one or more processors, cause a computerized apparatus to: transmit (a) a wireless synchronization signal or (b) wireless physical channel data, wherein the wireless synchronization signal comprises a periodically transmitted broadcast signal, and wherein the wireless physical channel data comprises a unicast signal directed to a user equipment (UE); and transmit a radar reference signal multiplexed with the wireless synchronization signal or the wireless physical channel data, wherein the radar reference signal is configured to, when correlated with a reflected version of the radar reference signal, serve as a basis for one or more radar measurements.

Clause 21: The non-transitory computer-readable apparatus of clause 20, wherein the plurality of instructions are further configured to, when executed by the one or more processors, cause the computerized apparatus to: select the wireless synchronization signal, the wireless synchronization signal comprising a synchronization signal block (SSB); and multiplex, in one or more of a time domain or a frequency domain, resources associated with the radar reference signal with resources associated with the SSB, resulting in a radar reference signal multiplexed with the SSB; wherein the transmission of the radar reference signal comprises a periodic broadcast of the radar reference signal multiplexed with the SSB from a transmission reception point (TRP).

Clause 22: The non-transitory computer-readable apparatus of any of clauses 20-21 wherein the plurality of instructions are further configured to, when executed by the one or more processors, cause the computerized apparatus to: select the wireless physical channel data, the wireless physical channel data corresponding to at least one physical channel; and multiplex, in one or more of a time domain or a frequency domain, resources associated with the radar reference signal with resources associated with the at least one physical channel, resulting in a radar reference signal multiplexed with the unicast signal; wherein the transmission of the radar reference signal comprises transmitting the radar reference signal multiplexed with the unicast signal from a transmission reception point (TRP); and wherein the at least one physical channel comprises a physical downlink shared channel (PDSCH).

Clause 23: The non-transitory computer-readable apparatus of any of clauses 20-22 wherein the plurality of instructions are further configured to, when executed by the one or more processors, cause the computerized apparatus to: multiplex the radar reference signal with the wireless synchronization signal or the wireless physical channel data in one or more of a time domain or a frequency domain according to an orthogonal frequency-division multiplexing (OFDM) scheme.

Clause 24: The non-transitory computer-readable apparatus of any of clauses 20-23 wherein the multiplexing of the radar reference signal with the wireless synchronization signal or the wireless physical channel data further comprises: allocation of a first set of time-frequency resources for the radar reference signal; and allocation of a second set of time-frequency resources for the wireless synchronization signal or at least a physical channel corresponding to the wireless physical channel data.

Clause 25: The non-transitory computer-readable apparatus of any of clauses 20-24 wherein the multiplexing of the radar reference signal with the wireless synchronization signal or the wireless physical channel data further comprises: evaluation of available time-frequency resources; selection of at least one OFDM symbol for the radar reference signal based at least on the available time-frequency resources; selection of a frequency band for the radar reference signal, the frequency band not occupied by the wireless synchronization signal or the wireless physical channel data; and allocation of resource elements for occupation of the radar reference signal according to the selected at least one OFDM symbol and the selected frequency band not occupied by the wireless synchronization signal or the wireless physical channel data.

Clause 26: A computerized apparatus comprising: means for transmitting (a) a wireless synchronization signal or (b) wireless physical channel data, wherein the wireless synchronization signal comprises a periodically transmitted broadcast signal, and wherein the wireless physical channel data comprises a unicast signal directed to a user equipment (UE); and means for transmitting a radar reference signal multiplexed with the wireless synchronization signal or the wireless physical channel data, wherein the radar reference signal is configured to, when correlated with a reflected version of the radar reference signal, serve as a basis for one or more radar measurements.

Clause 27: The computerized apparatus of clause 26, further comprising: means for selecting the wireless synchronization signal, the wireless synchronization signal comprising a synchronization signal block (SSB); and means for multiplexing, in one or more of a time domain or a frequency domain, resources associated with the radar reference signal with resources associated with the SSB, resulting in a radar reference signal multiplexed with the SSB; wherein the transmitting of the radar reference signal comprises periodically broadcasting the radar reference signal multiplexed with the SSB from a transmission reception point (TRP).

Clause 28: The computerized apparatus of any of clauses 26-27 further comprising means for selecting the wireless physical channel data, the wireless physical channel data corresponding to at least one physical channel; and means for multiplexing, in one or more of a time domain or a frequency domain, resources associated with the radar reference signal with resources associated with the at least one physical channel, resulting in a radar reference signal multiplexed with the unicast signal; wherein the transmitting of the radar reference signal comprises transmitting the radar reference signal multiplexed with the unicast signal from a transmission reception point (TRP); and wherein the at least one physical channel comprises a physical downlink shared channel (PDSCH).

Clause 29: The computerized apparatus of any of clauses 26-28 further comprising means for multiplexing the radar reference signal with the wireless synchronization signal or the wireless physical channel data in one or more of a time domain or a frequency domain according to an orthogonal frequency-division multiplexing (OFDM) scheme; wherein the means for multiplexing the radar reference signal with the wireless synchronization signal or the wireless physical channel data further comprises: means for allocation of a first set of time-frequency resources for the radar reference signal; and means for allocation of a second set of time-frequency resources for the wireless synchronization signal or at least a physical channel corresponding to the wireless physical channel data.

Clause 30: The computerized apparatus of any of clauses 26-29 further comprising means for multiplexing the radar reference signal with the wireless synchronization signal or the wireless physical channel data in one or more of a time domain or a frequency domain according to an orthogonal frequency-division multiplexing (OFDM) scheme; wherein the means for multiplexing the radar reference signal with the wireless synchronization signal or the wireless physical channel data further comprises: means for evaluating available time-frequency resources; means for selecting at least one OFDM symbol for the radar reference signal based at least on the available time-frequency resources; means for selecting a frequency band for the radar reference signal, the frequency band not occupied by the wireless synchronization signal or the wireless physical channel data; and means for allocating resource elements for occupation of the radar reference signal according to the selected at least one OFDM symbol and the selected frequency band not occupied by the wireless synchronization signal or the wireless physical channel data.

What is claimed is:

1. A method of multiplexing radar signals with communications signals, the method comprising:
transmitting (a) a wireless synchronization signal or (b) wireless physical channel data, wherein the wireless synchronization signal comprises a periodically transmitted broadcast signal, and wherein the wireless physical channel data comprises a unicast signal directed to a user equipment (UE); and
transmitting a radar reference signal multiplexed with the wireless synchronization signal or the wireless physical channel data, wherein the radar reference signal is configured to, when correlated with a reflected version of the radar reference signal, serve as a basis for one or more radar measurements.

2. The method of claim 1, further comprising:
selecting the wireless synchronization signal, the wireless synchronization signal comprising a synchronization signal block (SSB); and
multiplexing, in one or more of a time domain or a frequency domain, resources associated with the radar reference signal with resources associated with the SSB, resulting in a radar reference signal multiplexed with the SSB;
wherein the transmitting of the radar reference signal comprises periodically broadcasting the radar reference signal multiplexed with the SSB from a transmission reception point (TRP).

3. The method of claim 1, further comprising:
selecting the wireless physical channel data, the wireless physical channel data corresponding to at least one physical channel; and
multiplexing, in one or more of a time domain or a frequency domain, resources associated with the radar reference signal with resources associated with the at least one physical channel, resulting in a radar reference signal multiplexed with the unicast signal;
wherein the transmitting of the radar reference signal comprises transmitting the radar reference signal multiplexed with the unicast signal from a transmission reception point (TRP).

4. The method of claim 3, wherein the at least one physical channel comprises a physical downlink shared channel (PDSCH).

5. The method of claim 1, further comprising multiplexing the radar reference signal with the wireless synchronization signal or the wireless physical channel data in one or more of a time domain or a frequency domain according to an orthogonal frequency-division multiplexing (OFDM) scheme.

6. The method of claim 5, wherein the multiplexing the radar reference signal with the wireless synchronization signal or the wireless physical channel data further comprises:
allocating a first set of time-frequency resources for the radar reference signal; and
allocating a second set of time-frequency resources for the wireless synchronization signal or at least a physical channel corresponding to the wireless physical channel data.

7. The method of claim 6, wherein the first set of time-frequency resources for the radar reference signal comprises a subset of OFDM symbols occupied by the second set of time-frequency resources for the wireless synchronization signal or the at least physical channel corresponding to the wireless physical channel data.

8. The method of claim 6, wherein the first set of time-frequency resources for the radar reference signal comprises a subset of subcarriers occupied by the second set of time-frequency resources for the wireless synchronization signal or the at least physical channel corresponding to the wireless physical channel data.

9. The method of claim 6, wherein the first set of time-frequency resources is proximate to the second set of time-frequency resources by a prescribed extent in time or frequency.

10. The method of claim 5, wherein the multiplexing the radar reference signal with the wireless synchronization signal or the wireless physical channel data further comprises:
evaluating available time-frequency resources;
selecting at least one OFDM symbol for the radar reference signal based at least on the available time-frequency resources;
selecting a frequency band for the radar reference signal, the frequency band not occupied by the wireless synchronization signal or the wireless physical channel data; and
allocating resource elements for occupation of the radar reference signal according to the selected at least one OFDM symbol and the selected frequency band not occupied by the wireless synchronization signal or the wireless physical channel data.

11. The method of claim 1, further comprising multiplexing, in one or more of a time domain or a frequency domain, resources associated with the radar reference signal with resources associated with the wireless synchronization signal and resources associated with a Control Resource Set (CORESET) signal.

12. A transmission reception point (TRP) comprising:
one or more wireless communications interfaces;
memory; and
one or more processors communicatively coupled to the memory and the one or more wireless communication interface, and configured to:
transmit (a) a wireless synchronization signal or (b) wireless physical channel data, wherein the wireless synchronization signal comprises a periodically transmitted broadcast signal, and wherein the wireless physical channel data comprises a unicast signal directed to a user equipment (UE); and
transmit a radar reference signal multiplexed with the wireless synchronization signal or the wireless physical channel data, wherein the radar reference signal is configured to, when correlated with a reflected version of the radar reference signal, serve as a basis for one or more radar measurements.

13. The TRP of claim 12, wherein the one or more processors are further configured to:
select the wireless synchronization signal, the wireless synchronization signal comprising a synchronization signal block (SSB); and
multiplex, in one or more of a time domain or a frequency domain, resources associated with the radar reference signal with resources associated with the SSB, resulting in a radar reference signal multiplexed with the SSB;
wherein the transmission of the radar reference signal comprises a periodic broadcast of the radar reference signal multiplexed with the SSB from the transmission reception point (TRP).

14. The TRP of claim 12, wherein the one or more processors are further configured to:
select the wireless physical channel data, the wireless physical channel data corresponding to at least one physical channel; and
multiplex, in one or more of a time domain or a frequency domain, resources associated with the radar reference signal with resources associated with the at least one physical channel, resulting in a radar reference signal multiplexed with the unicast signal;
wherein the transmission of the radar reference signal comprises transmitting the radar reference signal multiplexed with the unicast signal from a transmission reception point (TRP).

15. The TRP of claim 14, wherein the at least one physical channel comprises a physical downlink shared channel (PDSCH).

16. The TRP of claim 12, wherein the one or more processors are further configured to multiplex the radar reference signal with the wireless synchronization signal or the wireless physical channel data in one or more of a time domain or a frequency domain according to an orthogonal frequency-division multiplexing (OFDM) scheme.

17. The TRP of claim 16, wherein the multiplexing of the radar reference signal with the wireless synchronization signal or the wireless physical channel data further comprises:
allocation of a first set of time-frequency resources for the radar reference signal; and
allocation of a second set of time-frequency resources for the wireless synchronization signal or at least a physical channel corresponding to the wireless physical channel data.

18. The TRP of claim 16, wherein the multiplexing of the radar reference signal with the wireless synchronization signal or the wireless physical channel data further comprises:
evaluation of available time-frequency resources;
selection of at least one OFDM symbol for the radar reference signal based at least on the available time-frequency resources;
selection of a frequency band for the radar reference signal, the frequency band not occupied by the wireless synchronization signal or the wireless physical channel data; and
allocation of resource elements for occupation of the radar reference signal according to the selected at least one OFDM symbol and the selected frequency band not occupied by the wireless synchronization signal or the wireless physical channel data.

19. The TRP of claim 12, wherein the one or more processors are further configured to multiplex, in one or more of a time domain or a frequency domain, resources associated with the radar reference signal with resources associated with the wireless synchronization signal and resources associated with a Control Resource Set (CORESET) signal.

20. A non-transitory computer-readable apparatus comprising a storage medium, the storage medium comprising a plurality of instructions configured to, when executed by one or more processors, cause a computerized apparatus to:
transmit (a) a wireless synchronization signal or (b) wireless physical channel data, wherein the wireless synchronization signal comprises a periodically transmitted broadcast signal, and wherein the wireless physical channel data comprises a unicast signal directed to a user equipment (UE); and
transmit a radar reference signal multiplexed with the wireless synchronization signal or the wireless physical channel data, wherein the radar reference signal is configured to, when correlated with a reflected version of the radar reference signal, serve as a basis for one or more radar measurements.

21. The non-transitory computer-readable apparatus of claim 20, wherein the plurality of instructions are further configured to, when executed by the one or more processors, cause the computerized apparatus to:
select the wireless synchronization signal, the wireless synchronization signal comprising a synchronization signal block (SSB); and
multiplex, in one or more of a time domain or a frequency domain, resources associated with the radar reference signal with resources associated with the SSB, resulting in a radar reference signal multiplexed with the SSB;
wherein the transmission of the radar reference signal comprises a periodic broadcast of the radar reference signal multiplexed with the SSB from a transmission reception point (TRP).

22. The non-transitory computer-readable apparatus of claim 20, wherein the plurality of instructions are further configured to, when executed by the one or more processors, cause the computerized apparatus to:
select the wireless physical channel data, the wireless physical channel data corresponding to at least one physical channel; and
multiplex, in one or more of a time domain or a frequency domain, resources associated with the radar reference signal with resources associated with the at least one physical channel, resulting in a radar reference signal multiplexed with the unicast signal;
wherein the transmission of the radar reference signal comprises transmitting the radar reference signal multiplexed with the unicast signal from a transmission reception point (TRP); and
wherein the at least one physical channel comprises a physical downlink shared channel (PDSCH).

23. The non-transitory computer-readable apparatus of claim 20, wherein the plurality of instructions are further configured to, when executed by the one or more processors, cause the computerized apparatus to:
multiplex the radar reference signal with the wireless synchronization signal or the wireless physical channel data in one or more of a time domain or a frequency domain according to an orthogonal frequency-division multiplexing (OFDM) scheme.

24. The non-transitory computer-readable apparatus of claim 23, wherein the multiplexing of the radar reference signal with the wireless synchronization signal or the wireless physical channel data further comprises:
allocation of a first set of time-frequency resources for the radar reference signal; and
allocation of a second set of time-frequency resources for the wireless synchronization signal or at least a physical channel corresponding to the wireless physical channel data.

25. The non-transitory computer-readable apparatus of claim 23, wherein the multiplexing of the radar reference signal with the wireless synchronization signal or the wireless physical channel data further comprises:
evaluation of available time-frequency resources;
selection of at least one OFDM symbol for the radar reference signal based at least on the available time-frequency resources;
selection of a frequency band for the radar reference signal, the frequency band not occupied by the wireless synchronization signal or the wireless physical channel data; and
allocation of resource elements for occupation of the radar reference signal according to the selected at least one OFDM symbol and the selected frequency band not occupied by the wireless synchronization signal or the wireless physical channel data.

26. A computerized apparatus comprising:
means for transmitting (a) a wireless synchronization signal or (b) wireless physical channel data, wherein the wireless synchronization signal comprises a periodically transmitted broadcast signal, and wherein the wireless physical channel data comprises a unicast signal directed to a user equipment (UE); and
means for transmitting a radar reference signal multiplexed with the wireless synchronization signal or the wireless physical channel data, wherein the radar reference signal is configured to, when correlated with a reflected version of the radar reference signal, serve as a basis for one or more radar measurements.

27. The computerized apparatus of claim 26, further comprising:
means for selecting the wireless synchronization signal, the wireless synchronization signal comprising a synchronization signal block (SSB); and
means for multiplexing, in one or more of a time domain or a frequency domain, resources associated with the radar reference signal with resources associated with the SSB, resulting in a radar reference signal multiplexed with the SSB;
wherein the transmitting of the radar reference signal comprises periodically broadcasting the radar reference signal multiplexed with the SSB from a transmission reception point (TRP).

28. The computerized apparatus of claim 26, further comprising:
means for selecting the wireless physical channel data, the wireless physical channel data corresponding to at least one physical channel; and
means for multiplexing, in one or more of a time domain or a frequency domain, resources associated with the radar reference signal with resources associated with the at least one physical channel, resulting in a radar reference signal multiplexed with the unicast signal;
wherein the transmitting of the radar reference signal comprises transmitting the radar reference signal multiplexed with the unicast signal from a transmission reception point (TRP); and
wherein the at least one physical channel comprises a physical downlink shared channel (PDSCH).

29. The computerized apparatus of claim 26, further comprising means for multiplexing the radar reference signal with the wireless synchronization signal or the wireless physical channel data in one or more of a time domain or a frequency domain according to an orthogonal frequency-division multiplexing (OFDM) scheme;
wherein the means for multiplexing the radar reference signal with the wireless synchronization signal or the wireless physical channel data further comprises:
means for allocation of a first set of time-frequency resources for the radar reference signal; and
means for allocation of a second set of time-frequency resources for the wireless synchronization signal or at least a physical channel corresponding to the wireless physical channel data.

30. The computerized apparatus of claim 26, further comprising means for multiplexing the radar reference signal with the wireless synchronization signal or the wireless physical channel data in one or more of a time domain or a frequency domain according to an orthogonal frequency-division multiplexing (OFDM) scheme;
wherein the means for multiplexing the radar reference signal with the wireless synchronization signal or the wireless physical channel data further comprises:
means for evaluating available time-frequency resources;
means for selecting at least one OFDM symbol for the radar reference signal based at least on the available time-frequency resources;
means for selecting a frequency band for the radar reference signal, the frequency band not occupied by the wireless synchronization signal or the wireless physical channel data; and
means for allocating resource elements for occupation of the radar reference signal according to the selected at least one OFDM symbol and the selected frequency band not occupied by the wireless synchronization signal or the wireless physical channel data.
